(19) United States
(12) Patent Application Publication
(10) Pub. No.: US 2002/0116232 A1
(43) Pub. Date: Aug. 22, 2002

(54) System and method for interactive scheduling

(76) Inventors: Larry J. Rapp, Powell, OH (US); David Pendleton Stagner, Lewis Center, OH (US); Gary L. Rapp, Dublin, OH (US)

Correspondence Address: STANDLEY & GILCREST LLP, 495 METRO PLACE SOUTH, SUITE 210, DUBLIN, OH, 43017, US

(21) Appl. No.: 09/741,601

(22) Filed: Dec. 18, 2000

(51) Int. Cl. G06F 17/60

(52) U.S. Cl. 705/5

(57) ABSTRACT

An automated system and method for interactive scheduling through a web site is disclosed. Vendors' appointment books are accessible through a web site so that customers may schedule appointments at any time and from any location. Customers access the vendor's appointment book by accessing the vendor's web site or selecting the vendor from a list of vendors maintained at a scheduling web site. Several cross-selling features are supported. In addition to scheduling a primary service, customers may schedule add-on and adjacent services that the vendor defines. Vendors who would like to establish a web site that uses special scheduling application software simply complete templates that comprise the content for the web site. A web site is then created for the vendor using service definitions and service provider information provided by the vendor.

### TECHNICAL FIELD

The present invention relates to systems and methods for scheduling an appointment with a vendor through the vendor's web site. More particularly, the present invention relates to a system and method that supports the development of a vendor web site with which the vendor's customers may interact to schedule appointments. The present invention further relates to a system and method that supports scheduling of add-on and adjacent services.

### BACKGROUND OF THE INVENTION

Many businesses today use a paper schedule for tracking customer appointments. Hair salons, golf courses, professional vendors, healthcare practices and others rely on the telephone for their customers to call and book an appointment. A customer can schedule an appointment using the telephone only if the telephone call is answered and someone is available to take the call, check the appointment book, and enter an appointment for the calling customer. Even if someone is available to take the telephone call, the customer and vendor representative may need to “negotiate” the day and time for the appointment. The customer expresses his or her preferences and the representative determines whether any appointments that meet the customer's preferences are available.

Using the telephone to schedule appointments is costly for both the customer and the vendor. Generally, customers may make appointments only when the business is open and available to take calls. The business' hours of availability for scheduling an appointment may not be convenient for the customer. Furthermore, the customer may be required to make several telephone calls before the call is answered or is answered by someone who can help. Once the customer reaches a representative who can help, the customer is required to spend time on the telephone and explain his or her preferences. The vendor must have enough telephone lines and representatives to answer the incoming calls. The vendor may lose customers if customers experience difficulties scheduling appointments.

### SUMMARY OF THE INVENTION

The present invention is an automated system and method for interactive scheduling through a web site. With the present invention, a vendor's appointment book is accessible through a web site so that customers may schedule appointments 24 hours a day and from any location. Customers access the vendor's schedule by accessing the vendor's web site or selecting the vendor from a list of vendors maintained at a scheduling web site.

The interactive scheduling system and method of the present invention comprises an internet-based application that allows vendors to manage their appointment books and allows customers to schedule appointments with vendors that use the system and method of the present invention. A vendor uses a browser to register with a scheduling web site. The vendor's online appointment book is made available through the scheduling web site. In addition, the vendor may receive a custom, personalized web site with posted information about the vendor's business, biographies of the vendor's service providers, digital photos, and maps. The present invention supports the exchange of email with customers, automated cross-selling of related products and services, and an online appointment book so that customers may schedule their own appointments. Vendors that may benefit from the present invention include personal care vendors (e.g., salons, barber shops, personal trainers), health care providers (e.g., dentists, physicians, optometrists, chiropractors), and auto care businesses (e.g., insurance helpdesks, body shops, auto repair shops).

The present invention comprises a plurality of software applications for managing a web-server based database of vendor content including descriptions of featured, add-on, and adjacent services and appointment book data, and a code generator to automatically create and modify individual vendor web sites and vendor content. Vendors that wish to take advantage of the present invention simply complete online web page forms or templates, and, with a click of a button, content is updated or a new web-site is created.

### BRIEF DESCRIPTION OF THE DRAWINGS

FIG. 1 is a block diagram of the primary hardware system components for an example embodiment of the present invention;

FIG. 2 is a software application data flow diagram for an example embodiment of the present invention;

FIG. 3 is a landing page in accordance with an example embodiment of the present invention;

FIG. 4 is a services page for a plurality of vendors in accordance with an example embodiment of the present invention;

FIG. 5 is a service provider page for a vendor in accordance with an example embodiment of the present invention;

FIG. 6 is a selected service provider page in accordance with an example embodiment of the present invention;

FIG. 7 is an appointment page in accordance with an example embodiment of the present invention;

FIG. 8 is a contact data confirmation page in accordance with an example embodiment of the present invention;

FIG. 9 is an appointment confirmation page in accordance with an example embodiment of the present invention;

FIG. 10 is a personal calendar web page for a customer in accordance with an example embodiment of the present invention;

FIG. 11 is a regular appointments page for a customer in accordance with an example embodiment of the present invention;

FIG. 12 is an appointments summary page for a vendor in accordance with an example embodiment of the present invention;

FIG. 13 is a customers summary page for a vendor in accordance with an example embodiment of the present invention;

FIGS. 14 and 15 are timeslot-blocking pages in accordance with an example embodiment of the present invention;

FIG. 16 is a comprehensive summary page for a vendor in accordance with an example embodiment of the present invention;

FIG. 17 is an add vendor page in accordance with an example embodiment of the present invention;

FIG. 18 is a service provider data entry page for an example embodiment of the present invention;

FIG. 19 is an add service page in accordance with an example embodiment of the present invention;

FIG. 20 is a service provider assignment page in accordance with an example embodiment of the present invention;

FIG. 21 is a service assignment page in accordance with an example embodiment of the present invention;

FIG. 22 is a promotions page in accordance with an example embodiment of the present invention; and

FIG. 23 is a vendor home page in accordance with an example embodiment of the present invention.

### DESCRIPTION OF EXAMPLE EMBODIMENTS

The interactive scheduling system and method of the present invention comprises software applications that allow vendors to manage their appointment books and allow customers to schedule appointments with vendors that use the system and method of the present invention. Vendors and customers equipped with only a browser tool such as America Online's Netscape or Microsoft's Internet Explorer may use the present invention. A vendor uses a browser to register with a scheduling web site and optionally, to receive a custom, personalized web site for the vendor with information about the vendor's business including biographies of the vendor's service providers, digital photos, and maps. Features include the exchange of email with customers, automated cross-selling of related products and services, and an online appointment book so that customers may schedule their own appointments through the vendor's web site or a scheduling web site maintained on behalf of many vendors.

A plurality of software applications collect data for and manage a web-server based database of vendor content and appointment book data. A code generator is used to automatically create and modify individual vendor web sites and vendor content. Vendors complete online web page forms or templates, to define content used to create a new web site.

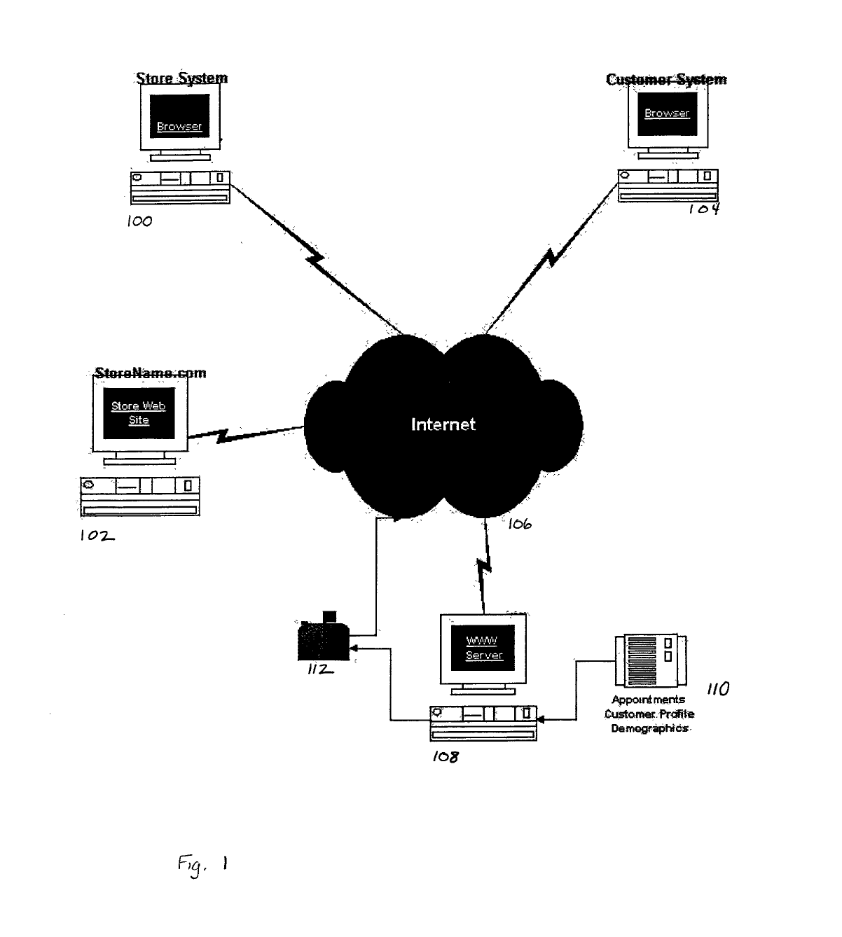

Referring to FIG. 1, a block diagram of the primary hardware system components for an example embodiment of the present invention is shown. As shown in FIG. 1, a vendor may use a computer equipped with a browser 100 to access through the Internet 106 a World Wide Web (WWW) server 108 (web server) that comprises a scheduling web site for accessing a database 110 with appointment information, customer profile information, and demographic information related to the customers of the vendor. A central appointment repository 110 is located at the web server 108, and is shared by all vendors. Each vendor may access the database to learn about its scheduled appointments as well as to administer the content for a web site created on behalf of the vendor. The vendor's web site may be operational on a different computer 102. The web server 108 further comprises software applications for sending email to customers of the vendor who have requested appointments with the vendor. A customer may use a computer equipped with a browser 104 to access the web site for the vendor 102. The customer may schedule an appointment by accessing the web site using a computer equipped with a browser. The appointment is scheduled on the web server 108 via a link from the vendor 102 to the web server 108. The customer may also use the computer 104 to access the scheduling web site at the web server 108 to review appointments that have been scheduled with several vendors and to update profile information that he or she has provided previously.

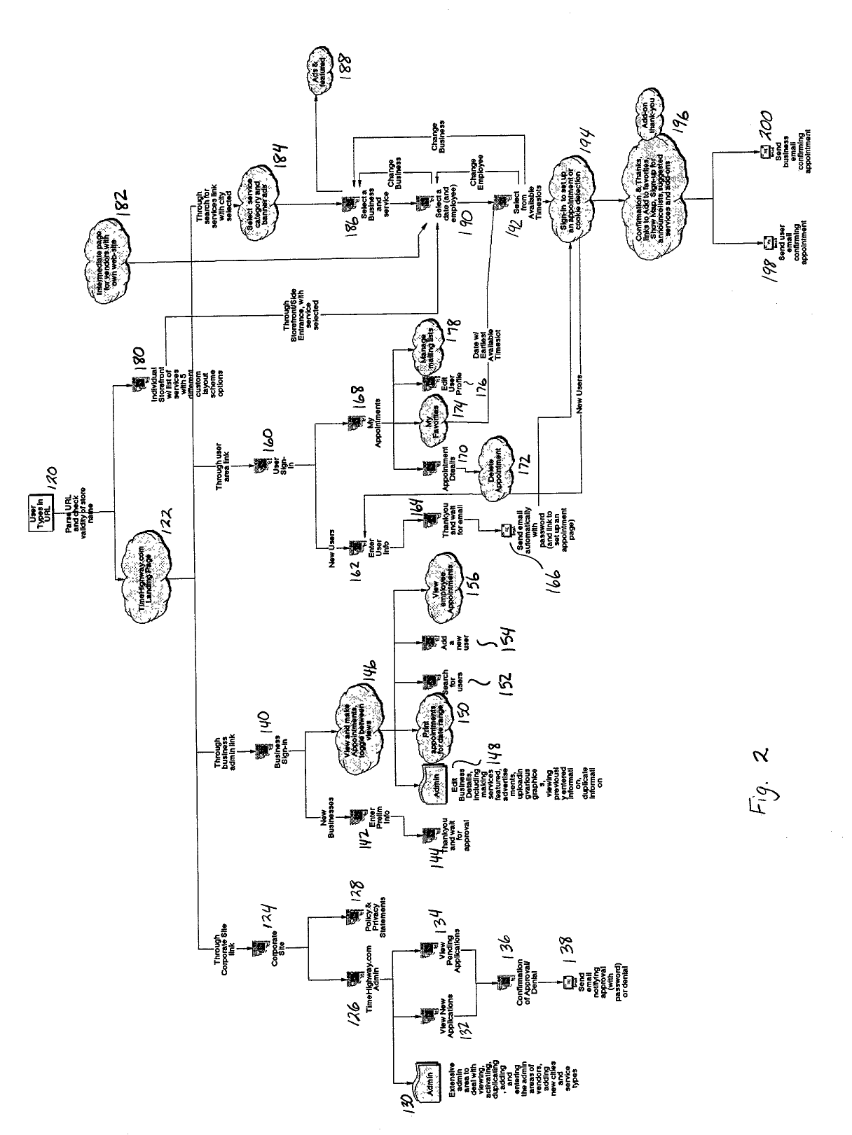

Referring to FIG. 2, a software application data flow diagram for an example embodiment of the present invention is shown. As shown in FIG. 2, in an example embodiment of the present invention, an appointment scheduling software application of the present invention is accessible via the Internet. A plurality of software applications provide the features and functionality of the present invention. The features and functionality of the present invention may be provided through one or more software applications distributed across one or more computers. Various design and performance considerations may be taken into account to determine the appropriate mix of applications and computers.

The two primary users of the appointment scheduling software application are vendors and customers of vendors. A vendor accesses an online appointment book to view the day's appointments, to schedule appointments for phone-in or walk-in customers, and to administer a database of customer profile information. In addition, a vendor may establish and administer a web site that its customers access to schedule their appointments. A user 120 who is a vendor may start at a landing page 122 that provides options for establishing service or viewing appointments that have been scheduled through the established service. Through a business site 140, a vendor user may access an application for administering a new service 142. The vendor completes forms or templates to provide information about the vendor and the scheduling services to be provided through the present invention.

Once an online appointment book has been created, the vendor may access the online appointment book to review scheduled appointments for each employee or service provider and, if necessary, add call-in or walk-in appointments to the appointment book 146. Service providers are individuals who provide services to customers. They are usually employees of the vendor. The vendor user may further print appointments 150 as well as search for and add customers 152, 154. The vendor user may also generate and review various reports related to appointments, customers, etc. In addition, service providers or employees of the vendor may view their personal appointment schedules to determine when they will be providing services to customers 156.

Customers who wish to schedule appointments may access services through a user link and sign-in area 160. New customers enter contact and other customer profile information 162. The customer data is stored in a customer profile database that includes the customer's email address. To maintain security and privacy, a unique user password is generated and emailed to the user in a matter of seconds. Upon approval of the customer profile information, the customer receives an acknowledgment 164 via email. In an example embodiment of the present invention, the email message contains a link to an appointment page so the customer may schedule an appointment with a selected vendor 166. Cookies are set to expedite the customer's login process. At the appointment page, the customer signs in and sets up an appointment 194. The customer's selections related to a vendor, service, service provider, and timeslot are communicated to an appointment scheduling software application. The customer then is provided with a confirmation of the appointment 196 and other information such as a map to the vendor's location. The customer may have the option of signing up for an announcement list. Notifications of events that may be of interest to the customer are sent to the customer via email or another means. Finally, email confirmations are sent to the customer 198 and the business 200.

The customer is also given the option of scheduling add-on and adjacent services 196. An add-on service is a service identified by the vendor as an additional service that may be offered and added on to a scheduled service at the same time as the primary service that the customer has scheduled. For example, an add-on may be “moustache trim.” When the customer sets up an appointment for a haircut, the customer may be given the option of the add-on service “moustache trim.” An adjacent service is a service identified by the vendor as an additional service that may be offered before or after a primary scheduled service. For a haircut appointment, an adjacent service may be a dyeing that is given to the customer after the haircut. Add-on and adjacent services, which are unique the present invention, allow a vendor to provide more comprehensive and complete services and to generate additional revenue. Customers benefit from the convenience of scheduling add-on and adjacent services in conjunction with primary services and obtaining primary, add-on, and adjacent services from a single vendor.

For customers who have scheduled several appointments with multiple vendors, the scheduled appointments may be viewed through a “my appointments” area 168 at the scheduling web site. The “my appointments area” comprises a personal calendar web page. Details regarding each appointment may be viewed 170, and appointments may be deleted 172. A “my regulars” area at the scheduling web site allows a customer to save information regarding preferred appointment times, vendors, etc. A “pick list” of user favorites is automatically generated and displayed on the customer's personal calendar web page. The pick list allows for quick and easy access to schedule an appointment with frequently used vendors. Using these options, the customer may choose a date with the earliest available timeslot and then select from available timeslots 192. At the appointment page, the customer signs in if he or she has not already done so via a cookie, and sets up an appointment 194. The customer then is provided with a confirmation of the appointment 196 and other information such as a map to the vendor's location. Finally, email confirmations are sent to the customer 198 and to the business 200. Customers also may edit their profiles 176 and manage their mailing lists 178.

A customer may schedule an appointment with a vendor by entering the application-generated web site of the vendor 180. The web site is linked to an appointment scheduling software application so that the features and functionality of the present invention may be presented to all customers, regardless of the point of entry. The vendor web site generated in accordance with the present invention has business-specific information such as service offerings, a map of and directions to the business location, digital pictures of the business and service providers, and promotional service offerings such as featured, add-on, adjacent services, and product advertisements. A customer accessing the appointment scheduling software application via the vendor's web site may select a service, and schedule an appointment by selecting a date and service provider or employee 190. The customer selects a timeslot from available timeslots 192. At the appointment page, the customer signs in and sets up an appointment 194. The customer then is provided with a confirmation of the appointment 196 and other information such as a map to the vendor's location. Finally, email confirmations are sent to the customer 198 and to the business 200. Additionally, a reminder email is sent to the customer “x # of days” prior to the appointment. The “x # of days” is controlled by the customer during the confirmation process.

A customer may also enter by way of the landing page 122 at the scheduling web site. First-time customers may select a service in a particular city, select a registered vendor, and schedule an appointment with that vendor. Individual storefronts for each vendor 180 may be accessible from the landing page 122. After selecting a service, the customer selects a date and service provider 190. The customer selects a timeslot from available timeslots 192 for the selected date. At the appointment page, the customer signs in and sets up an appointment 194. The appointment data related to the customer's selection of a vendor, service, service provider, date, and timeslot is stored at a central appointment repository. The customer then is provided with a confirmation of the appointment 196 and other information such as a map to the vendor's location. Finally, email confirmations are sent to the customer 198 and to the business 200.

For mobile users, another entry point may be based on the results of a search for services within a selected city 184. Next, the customer selects a vendor and service 186. After selecting a service, the customer selects a date and service provider 190. The customer selects a timeslot from available timeslots 192. At the appointment page, the customer signs in and sets up an appointment 194. The appointment data related to the customer's selection of a vendor, service, service provider, date, and timeslot is stored in a central appointment repository. The customer then is provided with a confirmation of the appointment 196 and other information such as a map to the vendor's location. Finally, email confirmations are sent to the customer 198 and to the business 200.

A unique feature of the present invention is the ability to generate custom web sites for vendors, and to automatically manage web site content through user-driven templates. An administration application accessible via a corporate site 124 supports the design, development, and implementation of web sites and scheduling applications for various vendors. Administration for a corporate web site 126 is supported. A landing page 122 that vendor users use to enter a corporate web site is maintained through the administration module 126. The user of the administration module is typically a corporate webmaster or a vendor administrator. At the administration module, a user may add, update, or delete content. To add a new vendor, the administrator simply completes an online data-entry form, and submits the form. In the administration area 130, information regarding services, vendors, and vendor locations is entered and maintained through the online data-entry forms. The service information may comprise information about add-on and adjacent services. Vendors may further select among additional features supported by the appointment scheduling software application such as automatic reminder emails to customers who have scheduled appointments. In addition, procedures for viewing new 132 and pending 134 applications are provided. Confirmation procedures 136, 138 are also supported.

The information provided by the vendor 144 is reviewed and if the information is appropriate, the vendor's request for service is approved 144. Following approval, the activation process automatically generates a web site with its own URL name for the vendor. The vendor web site becomes accessible by customers for selecting a service and scheduling appointments, locating the business on a map, and viewing company and service provider profile information. Also upon approval, an appointment book for the vendor is created. Information entered into the vendor's appointment book is maintained at a central appointment repository. An administration module 148 that comprises templates supports the development and maintenance of the vendor web site. The administration module 148 supports the definition of service offerings (including add-on and adjacent services), the cost of the services, and the length of time for the services. This information is used as appointments are scheduled.

With the present invention, a vendor simply answers questions and provides specific information that may then be used to create a web site tailored to the vendor's business. The vendor information is integrated with an appointment scheduling software application and other software applications to provide the full features and functionality needed by customers of the vendor. An online appointment book is created on behalf of the vendor. The online appointment book is maintained at a central appointment repository. The process of developing a vendor web site as well as creating and maintaining an appointment book is efficient and simple. More importantly, it is cost-effective because the vendor is not required to devote resources to the development and maintenance of a web site and appointment book that supports interactive scheduling.

The appointment scheduling software application that links to vendor web sites provides the following functionality. When a customer selects a service and time, the application verifies that the selected service fits the selected timeslot. The customer is notified immediately if there is a conflict. A confirmation page is displayed to the customer thanking the customer, and providing a link to the vendor's web site to obtain directions to the business. An email message is sent to the customer and to the vendor to confirm the scheduled appointment. Additionally, an email reminder may be automatically generated and sent prior to the appointment.

The appointment scheduling software application further supports “double book” appointments based on the vendor's preferences. Using this feature, more than one appointment may be scheduled for the same time period. For example, a dentist or other healthcare professional may want to see two patients at the same time.

At the time the appointment is confirmed, the appointment scheduling software application further provides “cross-selling” capabilities that comprise featured, add-on, and adjacent services. The application locates “add-on” services that are related to the scheduled service and recommends to the customer the additional services that may be performed at the same time as the scheduled appointment. For example, a customer may have scheduled an appointment for a haircut with Joe at 1:00 PM at Joe's Barber Shop. The application may notify the customer that Helen is available at 1:00 PM to provide the add-on service of a manicure. The application offers this service during the confirmation process for the requested appointment. If the customer chooses the add-on service for his appointment, the service provider providing the add-on service, as well as the service provider providing the primary service, is notified.

Likewise, adjacent services (provided immediately before or after the scheduled appointment) may also be offered. Both cross-selling features of add-in and adjacent services are vendor-driven. During administration, a vendor may request that promotions for add-in and adjacent services as well as featured services be included in its appointment scheduling process. The vendor may also disable the feature at any time through the administration application.

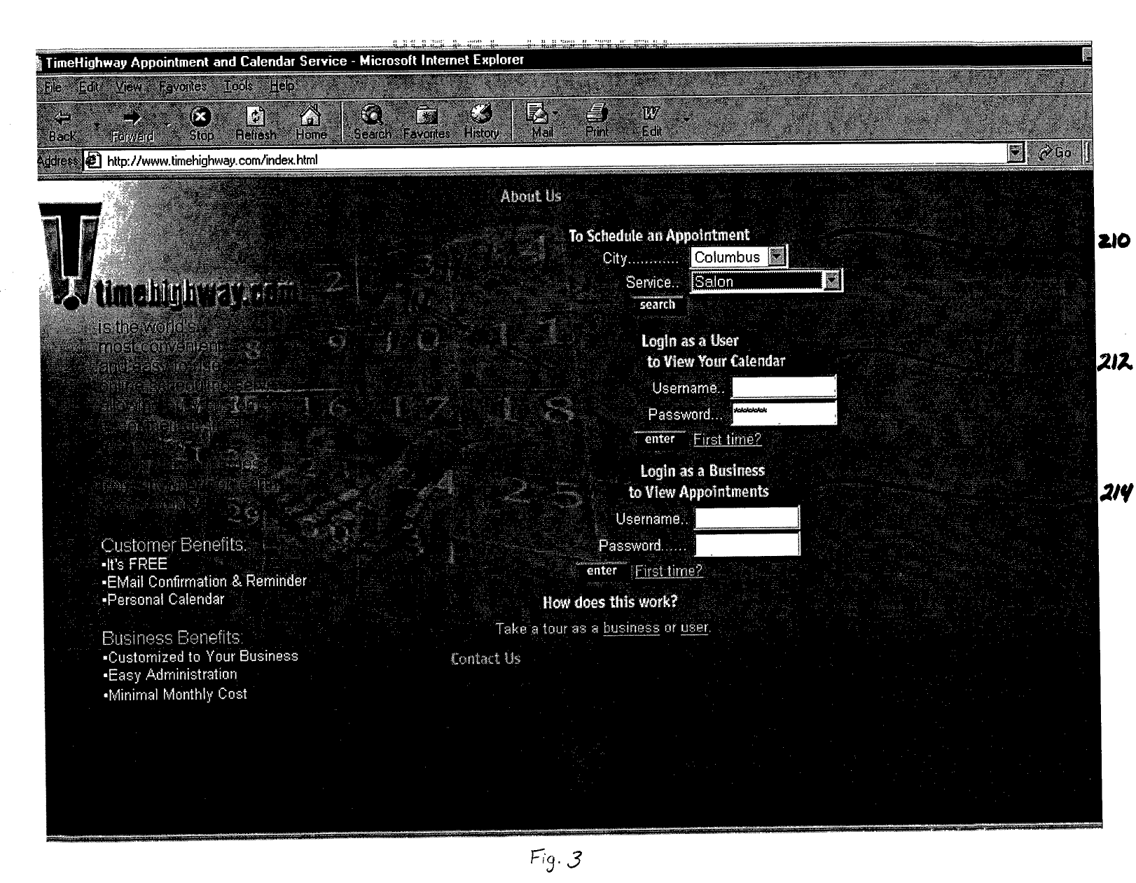

Referring to FIG. 3, a landing page in accordance with an example embodiment of the present invention is shown. The landing page at the scheduling web site provides three entry points to the appointment scheduling software application and related software applications of the present invention. The first entry point 210 allows a customer to start the process of scheduling an appointment. The second entry point 212 allows a customer to view his or her personal calendar web page or “my appointments” area. Finally, the third entry point allows a vendor to view appointments that have been scheduled by customers of the vendor.

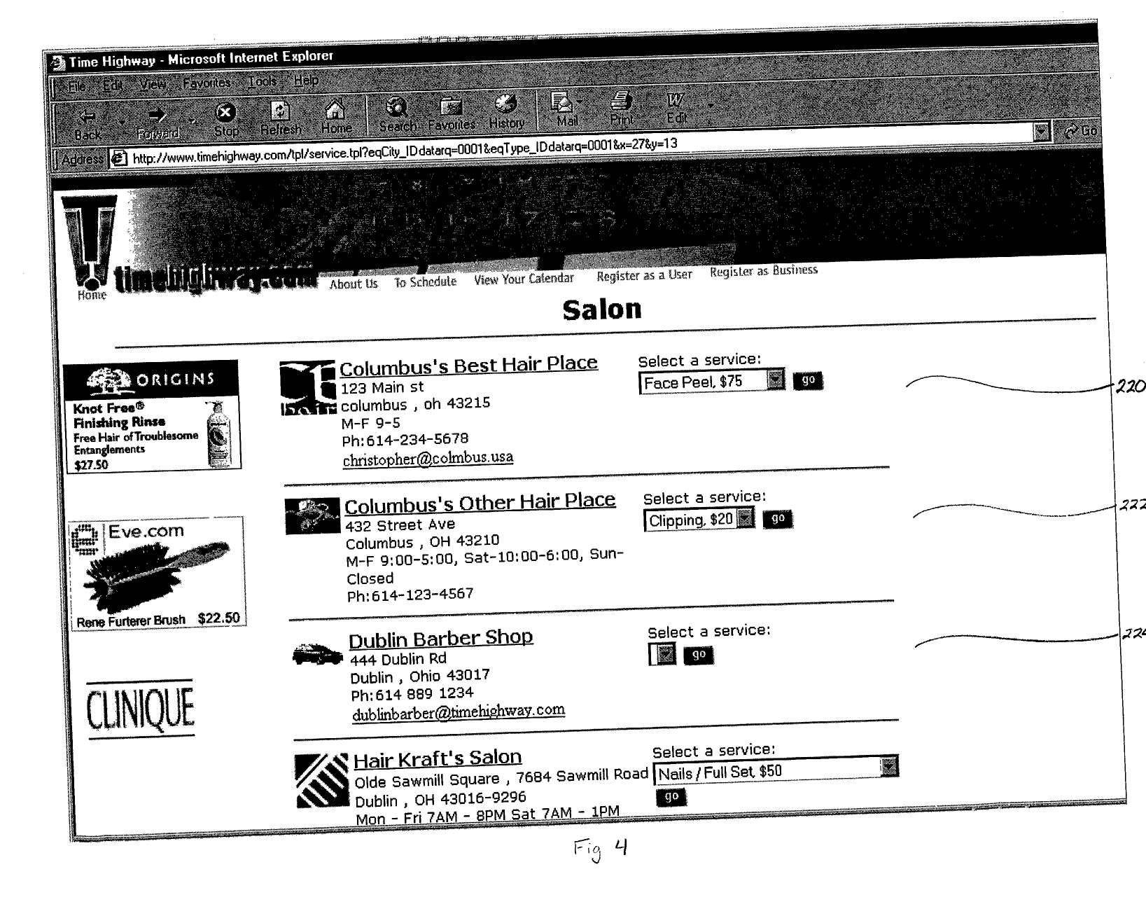

Referring to FIG. 4, a services page for a plurality of vendors in accordance with an example embodiment of the present invention is shown. For each vendor 220, 222, 224, a link to a web site for the vendor is displayed and a default service for a pulldown menu of services is displayed. The customer may leave the default service or select a different service and select a “Go” button to begin the process of scheduling an appointment for the selected service.

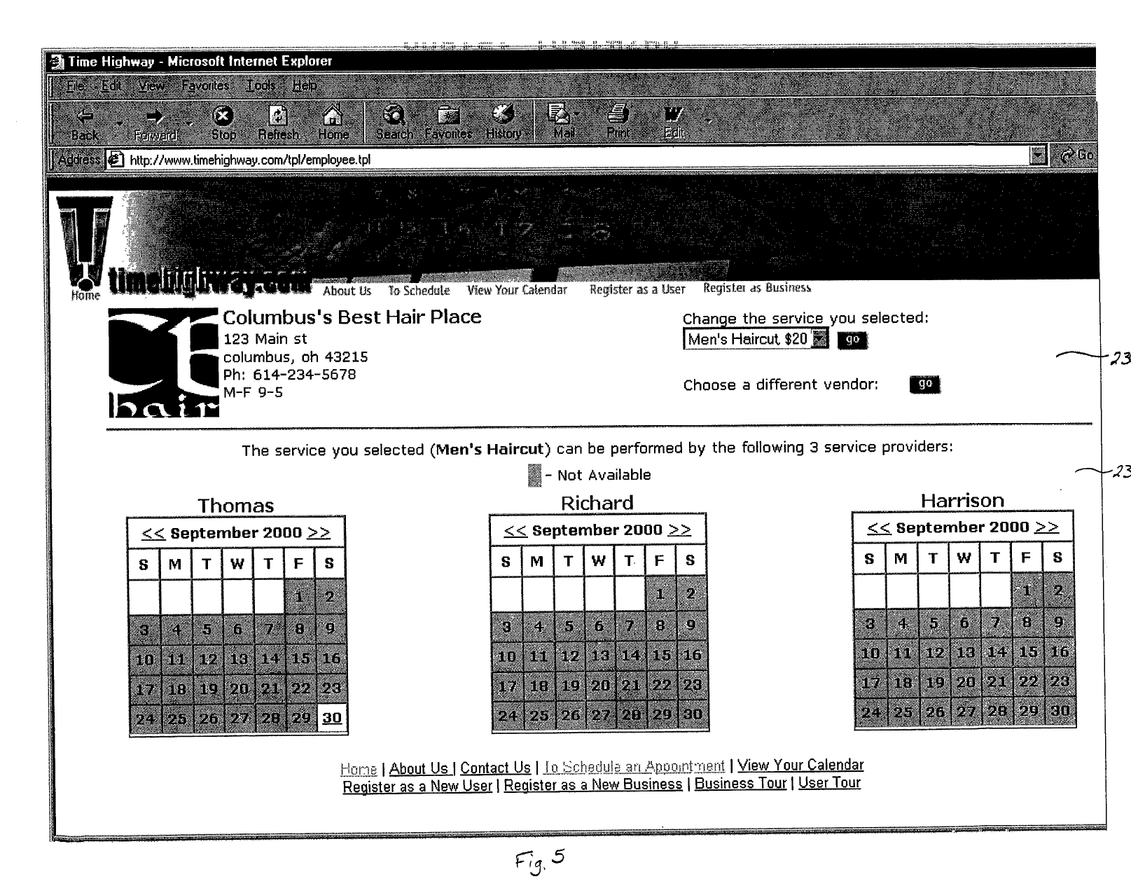

Referring to FIG. 5, a service provider page for a vendor in accordance with an example embodiment of the present invention is shown. Although employees of the vendor typically provide services, any individual who can provide the service may be identified as the service provider. The name of the vendor and the selected service are shown at the top of the page 230. The customer may change the selected service or choose a different vendor. The bottom portion of the page displays the calendars for the employees or service providers who can provide the selected service. Colors or other visual indicators may be used to indicate the availability of each of the service providers. For example, a white background and underline on September 30 for the service provider identified as “Thomas” indicates the availability of the service provider.

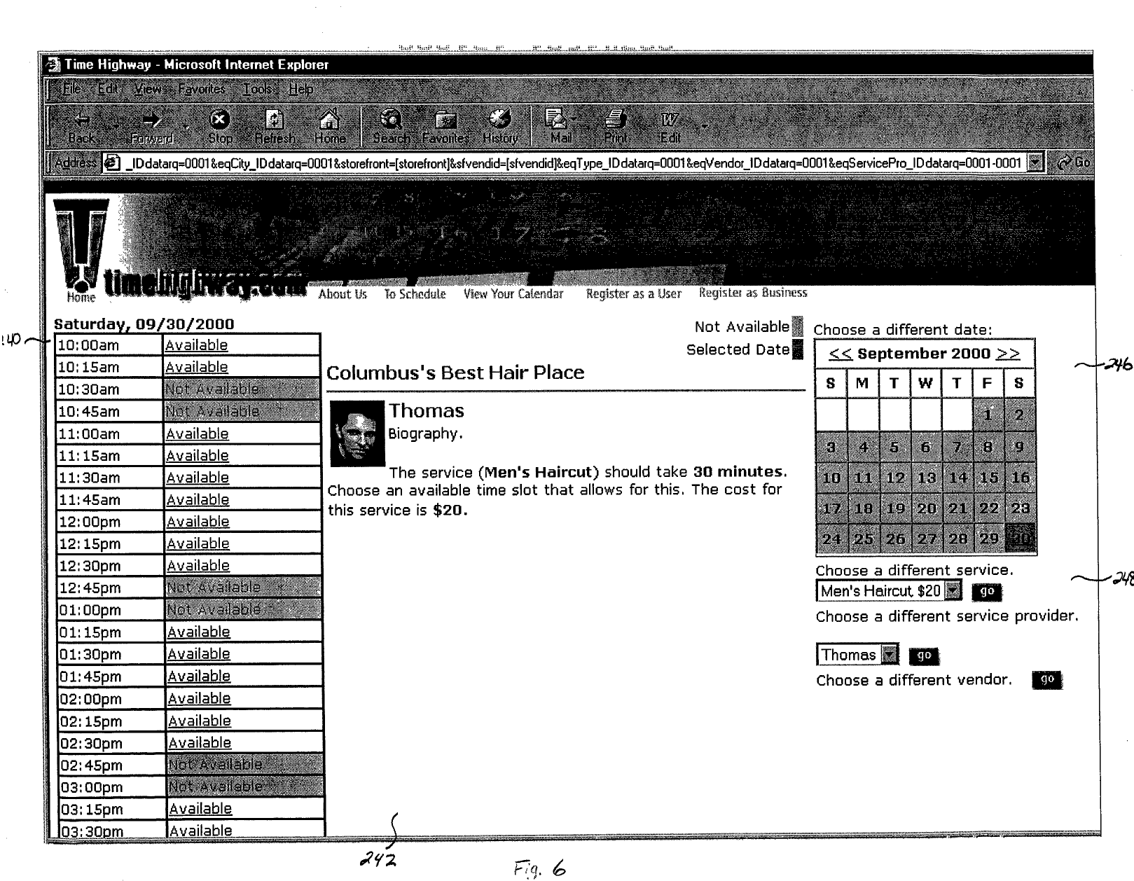

Referring to FIG. 6, a selected service provider page in accordance with an example embodiment of the present invention is shown. At the left of the page 240, a list of the timeslots for the selected service provider is displayed. For each timeslot, the availability of the service provider is indicated. In the middle of the page, a description of the service provider and selected service is displayed 242. Finally, at the right of the page, options for changing the date of the service 246, type of service, service provider, or vendor 248 are displayed.

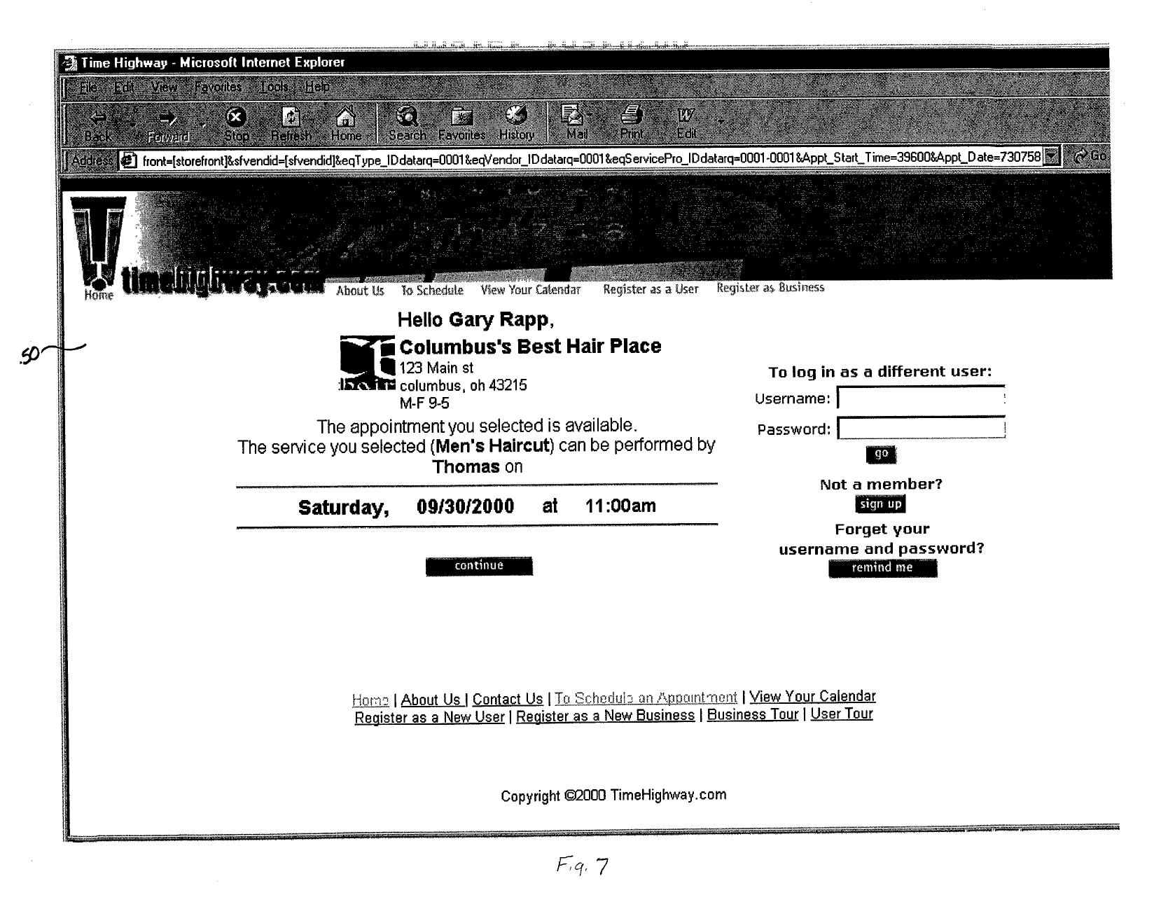

Referring to FIG. 7, an appointment page in accordance with an example embodiment of the present invention is shown. The customer's name, the vendor's name, the selected service, the selected service provider, and the selected date and time are displayed 250. After reviewing this information, the customer may select the “Continue” button to continue with the scheduling process.

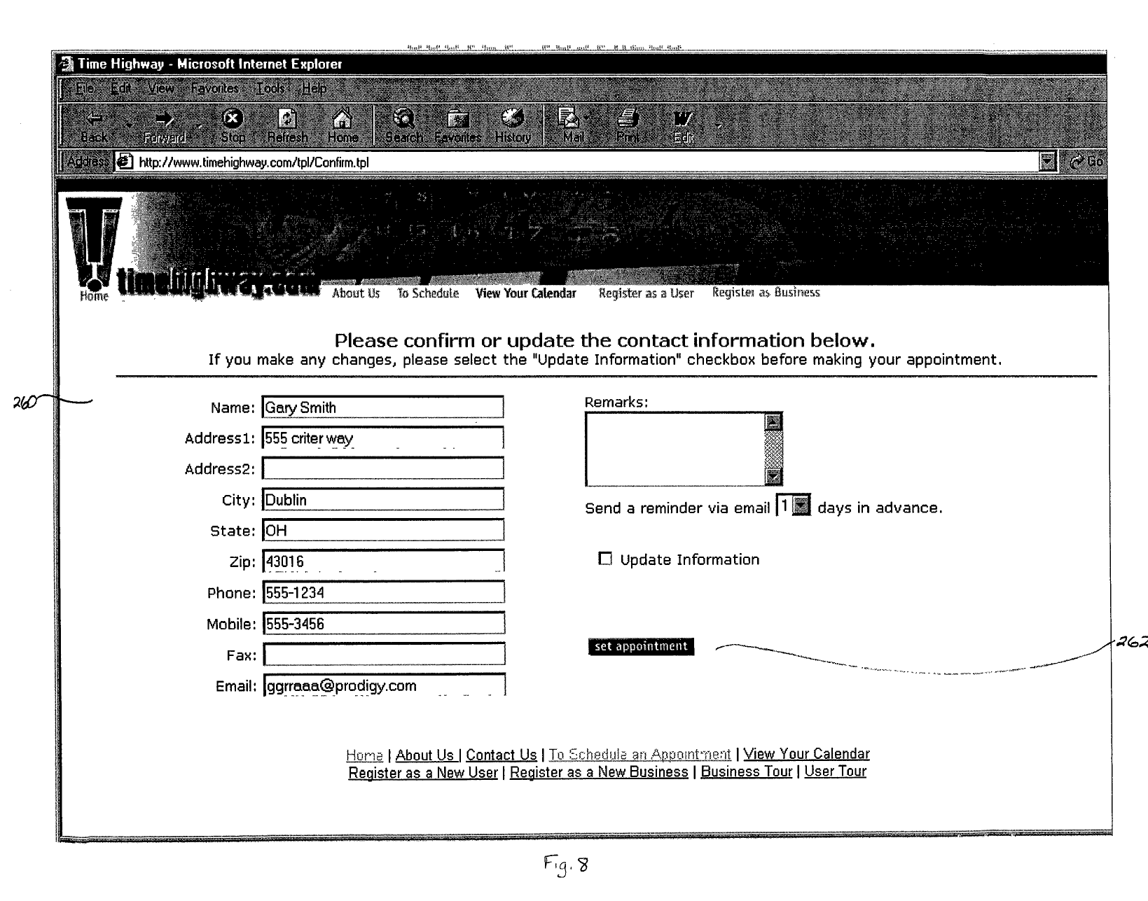

Referring to FIG. 8, a contact data confirmation page in accordance with an example embodiment of the present invention is shown. The customer may review and update the information displayed on the page as appropriate 260. The customer may also specify when a reminder email message is to be sent. Finally, by selecting the “Set Appointment” button, the scheduling process may be completed. The central appointment repository is updated with the appointment information for the selected vendor, service provider, and timeslot.

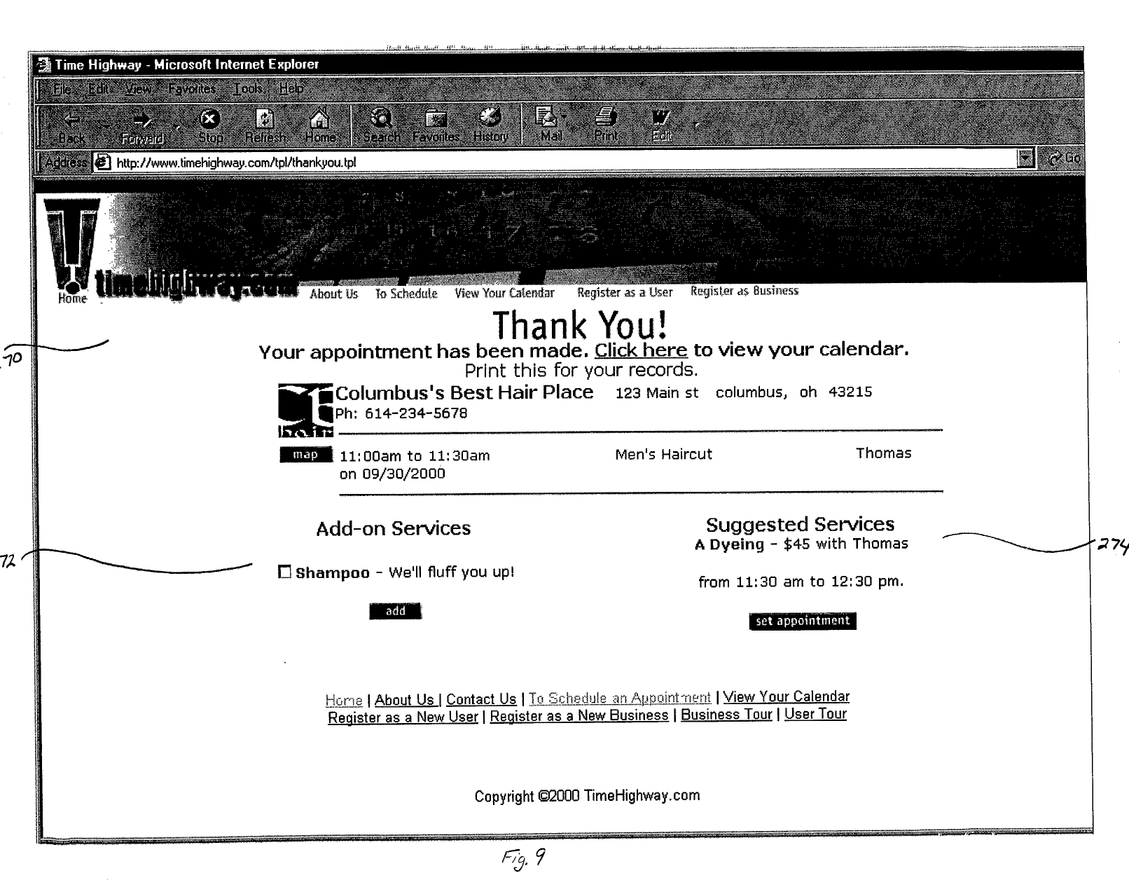

Referring to FIG. 9, an appointment confirmation page in accordance with an example embodiment of the present invention is shown. The top of the page 270 displays the details regarding the scheduled appointment. Information regarding vendor, date, time, service, and service provider is displayed. In addition, information regarding add-on services 272 and adjacent or featured services 274 is displayed. The add-on service may be scheduled for the same time as the primary appointment. For example, as shown in FIG. 9, a shampoo service 272 may be provided in conjunction with the appointment for the haircut scheduled by the customer. The adjacent service, which requires additional time, may be provided immediately before or after the scheduled service. For example, as shown in FIG. 9, a dye or color service 274 may be provided immediately following the scheduled haircut.

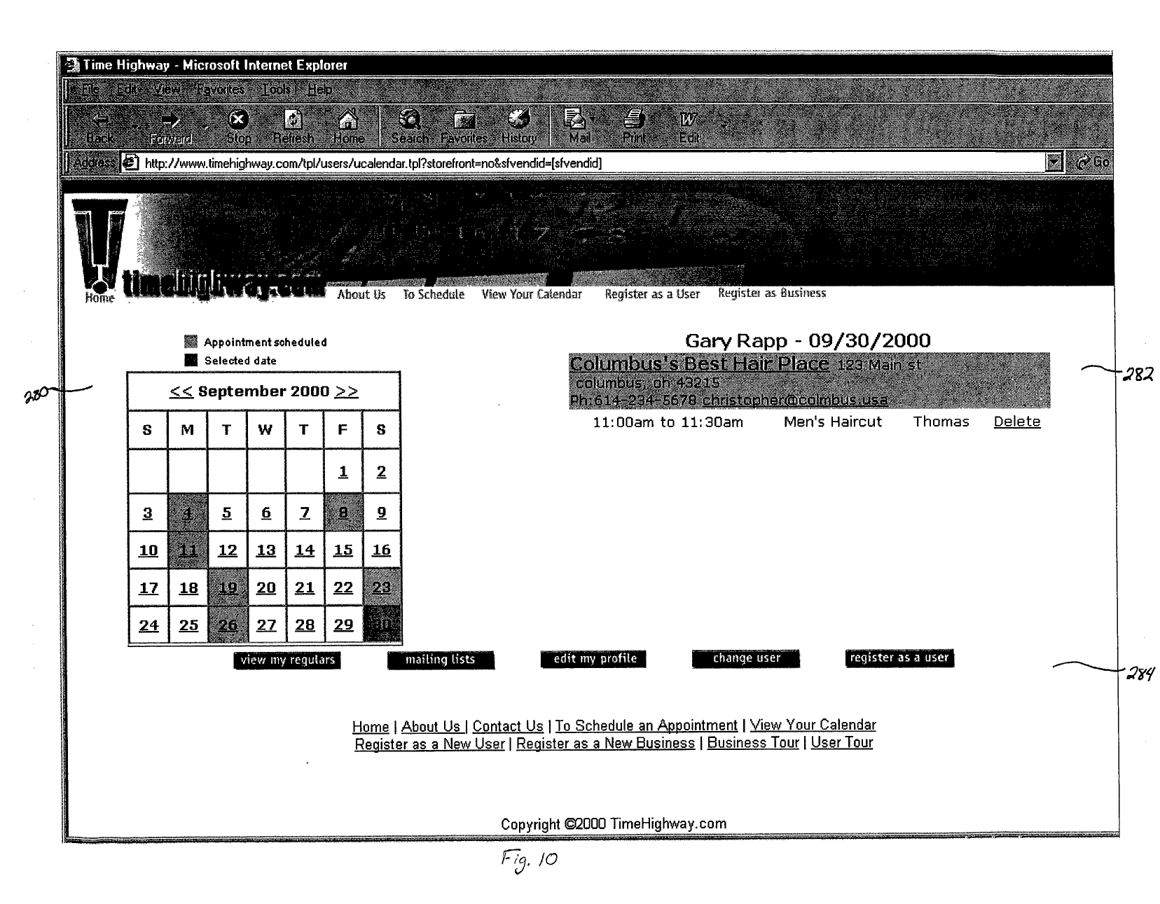

Referring to FIG. 10, a personal calendar web page for a customer in accordance with an example embodiment of the present invention is shown. A calendar indicating the days for which the customer has scheduled appointments is displayed at the left of the page 280. At the right of the page, details regarding the customer's scheduled appointments are displayed 282. Finally, at the bottom of the page, the customer is provided with options for viewing regular appointments, editing mailing lists, editing profile information, changing user names, and registering as a user 284.

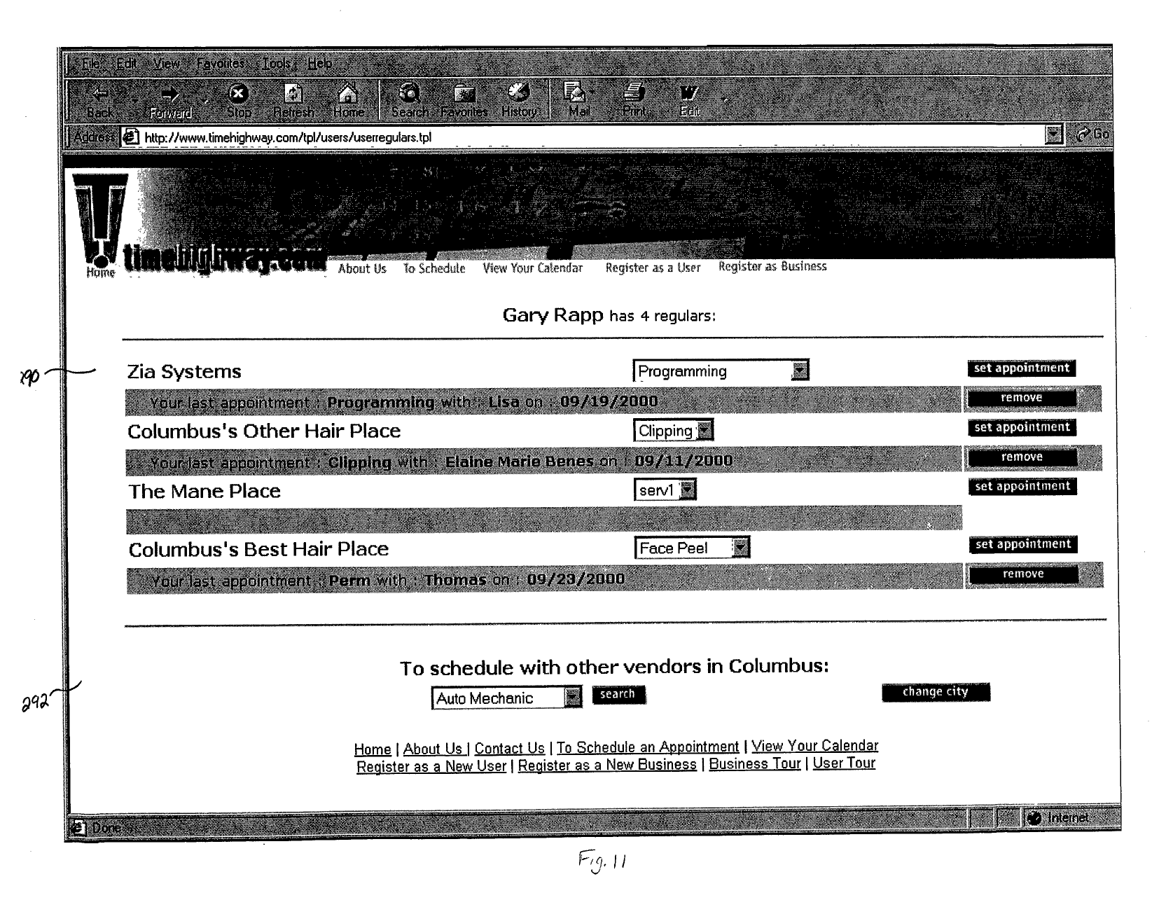

Referring to FIG. 11, a regular appointments page for a customer in accordance with an example embodiment of the present invention is shown. Details regarding earlier appointments are displayed at the top of the page 290. Information from previous appointments, which is stored and maintained at the central appointment repository, may be used in scheduling new appointments so that the customer is not required to enter the information again. The customer may select a “Set Appointment” option to schedule a new appointment with the same service provider of the identified vendor or the customer may remove the appointment from his or her personal calendar. Finally, at the bottom of the page 292, the customer has the option of scheduling additional appointments with other vendors.

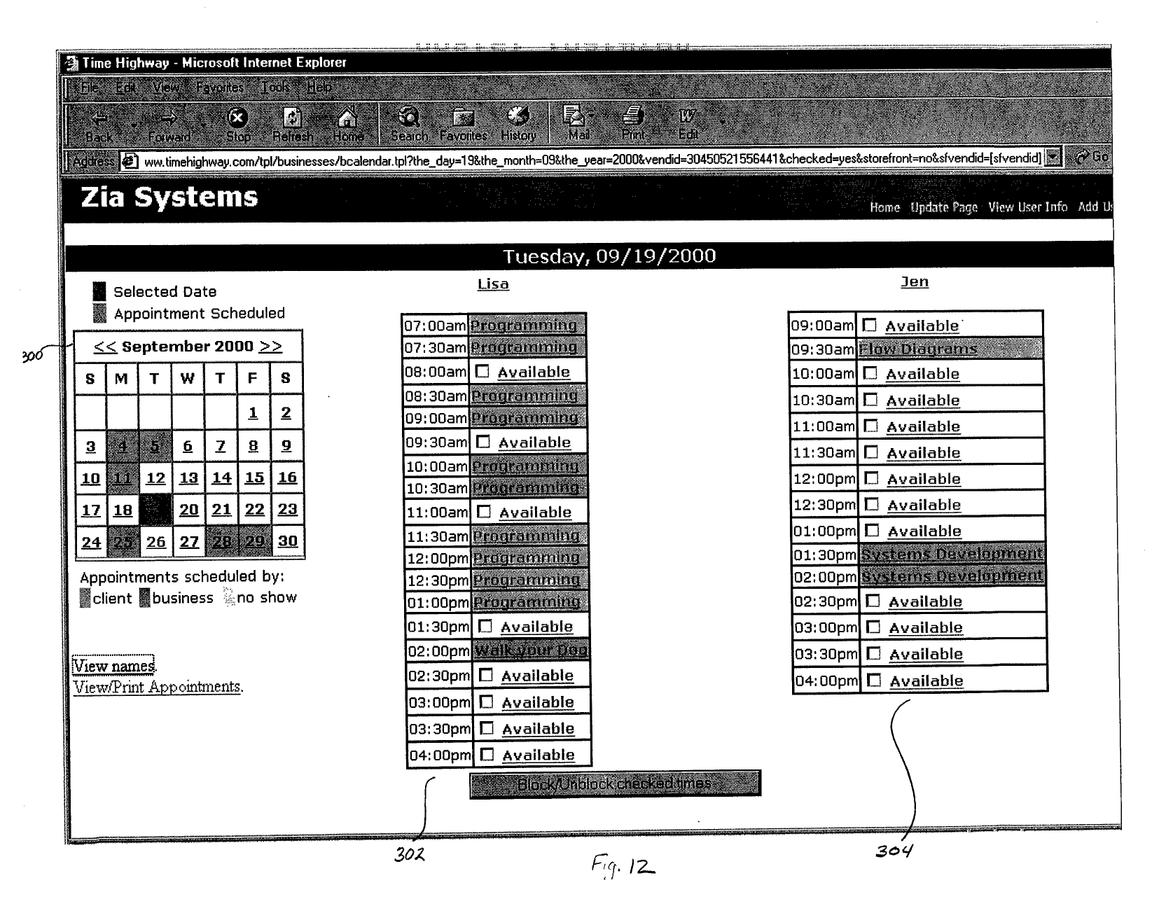

Referring to FIG. 12, an appointments summary page for a vendor in accordance with an example embodiment of the present invention is shown. A vendor user may review service provider schedules by accessing this page. A calendar is displayed at the left of the page 300. The user selects a date from the calendar and the service provider or employee schedules for the selected date are displayed for the user. For example, as shown in FIG. 12, daily schedules for two service providers 302, 304 may be displayed. In each timeslot of the daily schedule, a description of the appointment is displayed. Clicking on a timeslot containing an appointment causes a window to display additional information regarding that appointment. Through this page, the user may block or unblock different timeslots for the selected service provider's daily schedule.

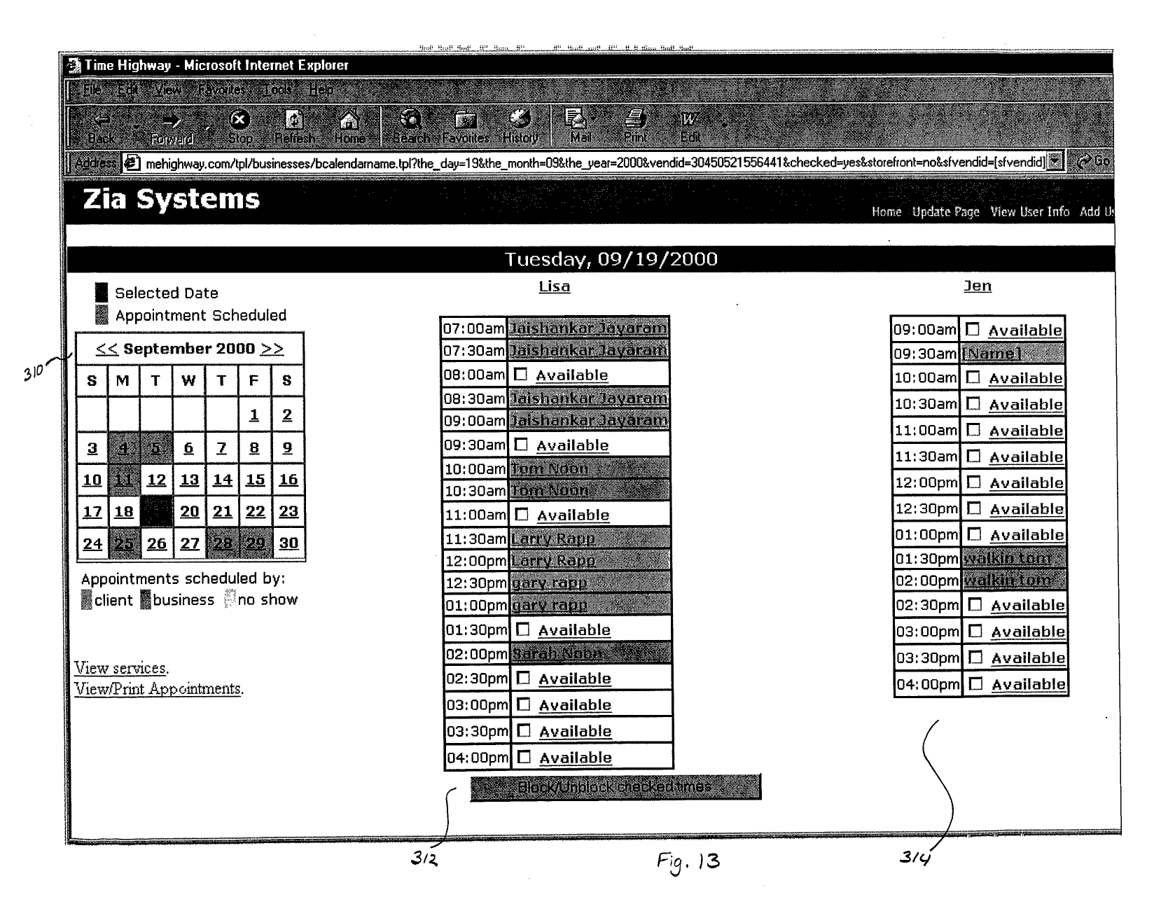

Referring to FIG. 13, a customers summary page for a vendor in accordance with an example embodiment of the present invention is shown. A vendor user may review service provider or employee schedules by accessing this page. A calendar is displayed at the left of the page 310. The user selects a date from the calendar and the service provider schedules for the selected date are displayed for the user. For example, as shown in FIG. 13, daily schedules for two service providers 312, 314 may be displayed. In each timeslot of the daily schedule, the name of the customer who scheduled the appointment is displayed. Through this page, the user may block or unblock different timeslots for the selected service provider's daily schedule.

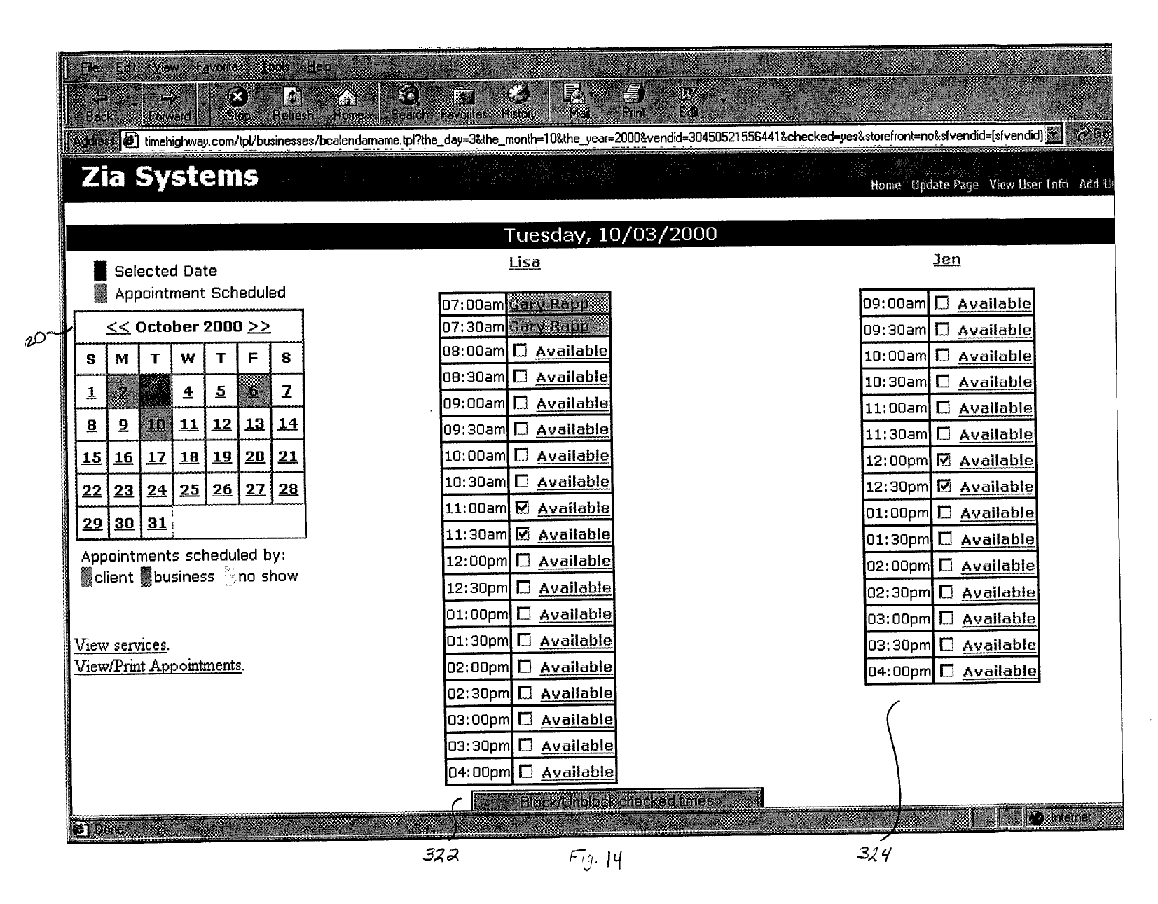

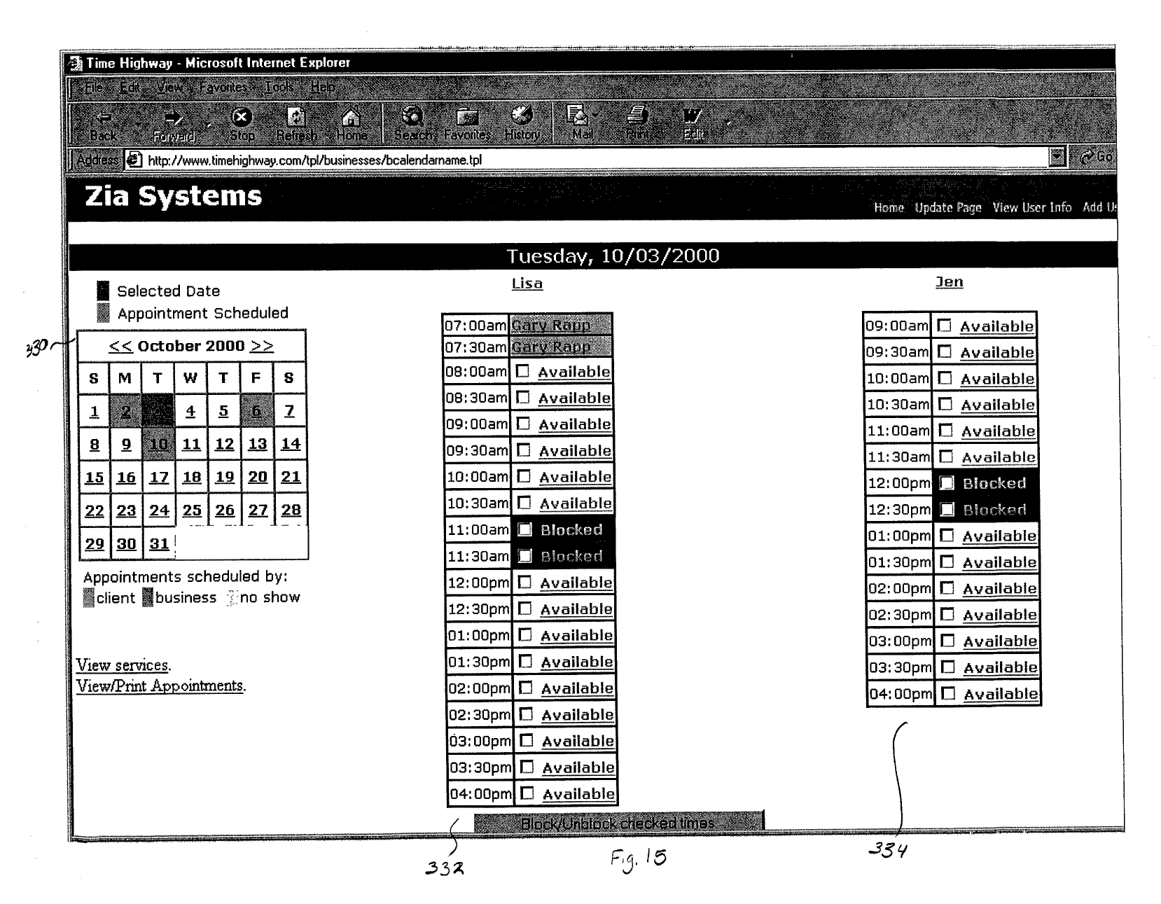

Referring to FIGS. 14 and 15, timeslot-blocking pages for an example embodiment of the present invention are shown. A vendor user may choose to block or unblock certain timeslots for a service provider based on the needs of the business. For example, the vendor may choose to close the business early on a particular day. Therefore, the vendor would like to be able to block timeslots after 3:00 PM for all service providers so that customers cannot schedule appointments after 3:00 PM. Referring to FIG. 13, a calendar 320 is displayed at the left of the page so the vendor user can select a date. The vendor user may select available timeslots for each service provider 322, 324 based on the service provider schedules for the selected day. Upon selection of the “Block/Unblock Check Times” button, the selected timeslots are blocked or unblocked as appropriate. Referring to FIG. 15, the timeslots selected earlier 332, 334 are displayed as blocked or available depending upon their previous states.

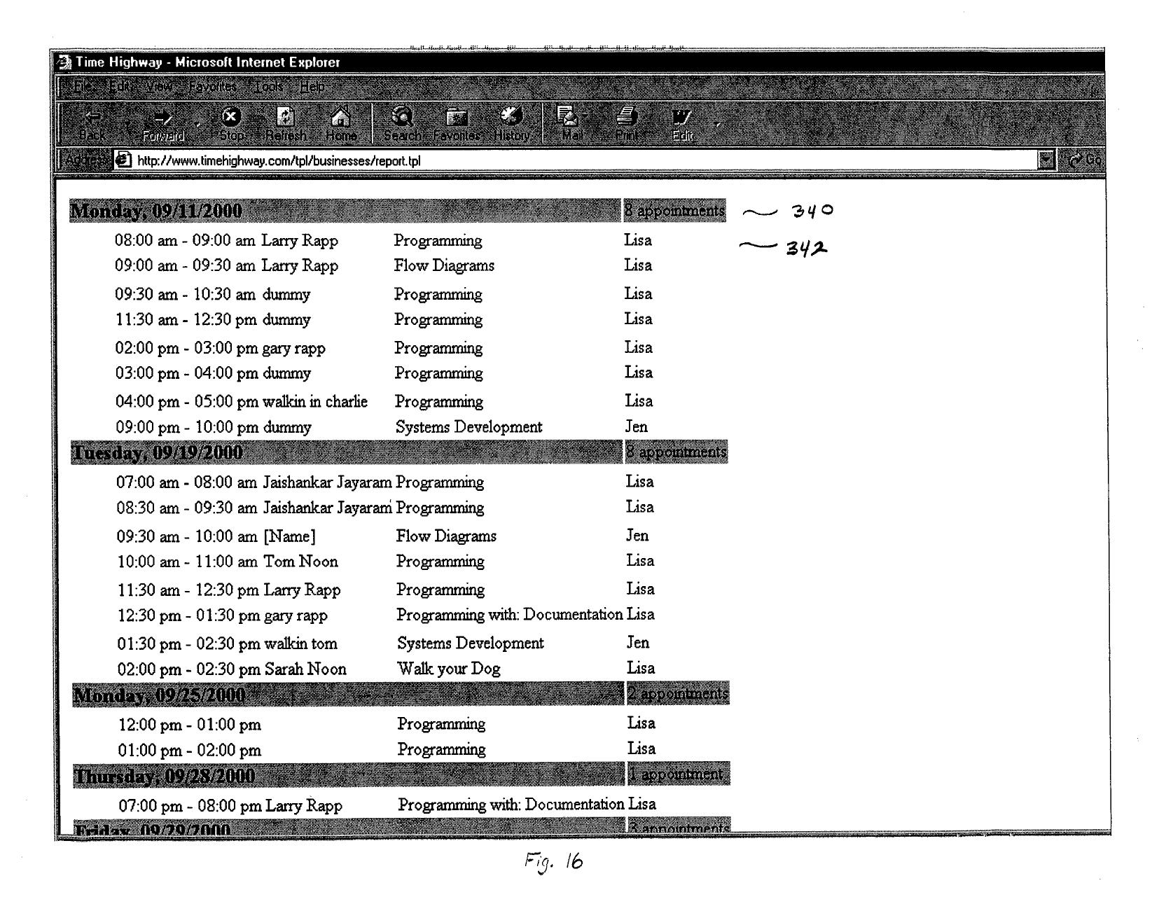

Referring to FIG. 16, a comprehensive summary page for a vendor in accordance with an example embodiment of the present invention is shown. A vendor user may view a chronological summary of appointments. For each day in the summary, the total number of appointments is shown 340. In addition, details regarding each appointment (time, customer, service, and service provider) are shown 342.

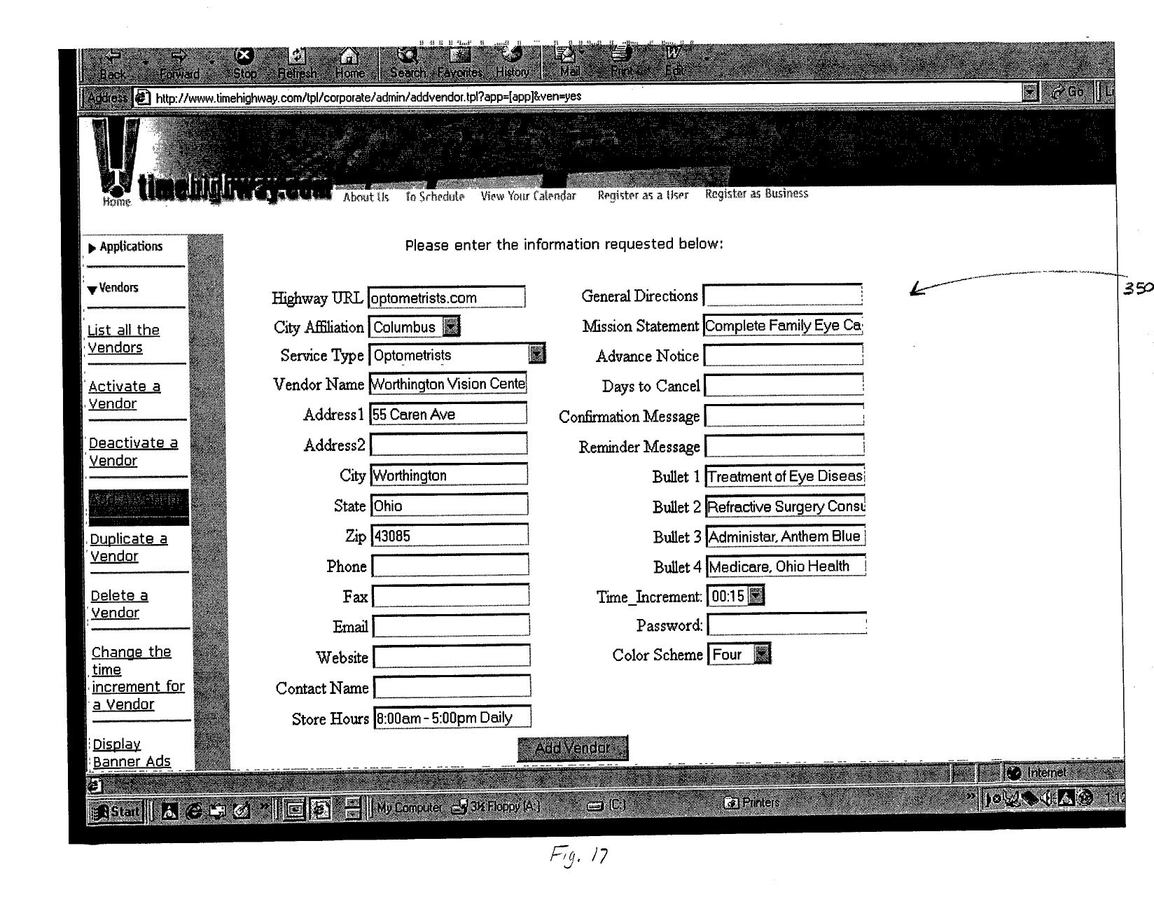

Referring to FIG. 17, an add vendor page in accordance with an example embodiment of the present invention is shown. The vendor specifies the information requested on the form 350 so that a web site can be created for the vendor. The vendor enters a name and address. The vendor further specifies an email address so that it can receive appointment confirmations. A general business or service type classification of the vendor (e.g., salon, consultant, kennel, etc.) is also specified. A brief description or mission statement of the vendor, plus up to four bullet points that describe the business are entered. Also specified are the hours of business (e.g., Mon-Fri from 8AM-5PM) and schedule increments (e.g., 1/2 Hour or 1 Hour timeslots for scheduling). Next, a unique URL for the vendor is specified. A copy of the vendor's logo in electronic format may be uploaded for use at the web site.

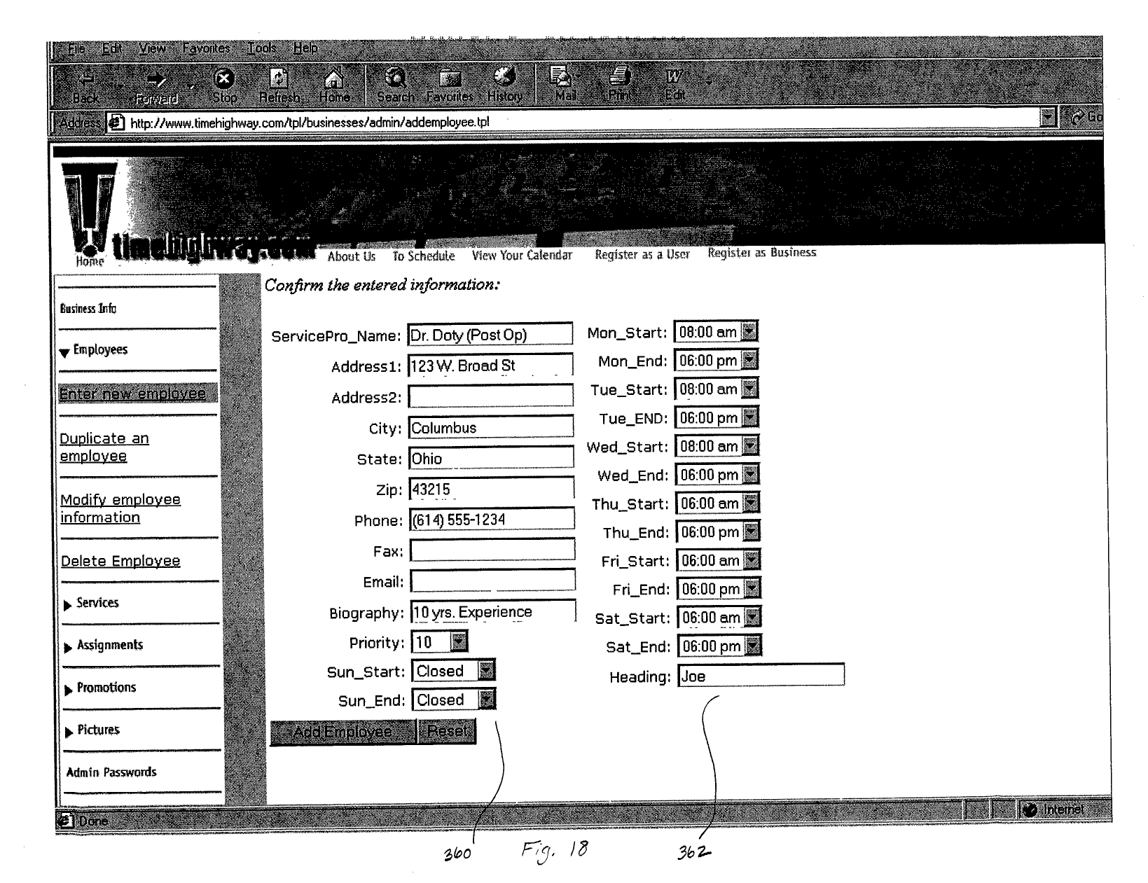

Next, the vendor determines the number of unique appointment books that are required. Generally, one appointment book per service provider providing services is required (e.g., one per doctor, one per hair stylist). However, in some instances, only one appointment book may be necessary for the business even though multiple service providers provide services. Referring to FIG. 18, a service provider data entry page for an example embodiment of the present invention is shown. For each service provider, biographical information 360 and hours of availability 362 may be specified. Each added service provider results in the creation of an appointment book. The information entered through this page establishes the various appointment books for the vendor. Using other pages, each service provider entered is matched with the list of services offered by the vendor.

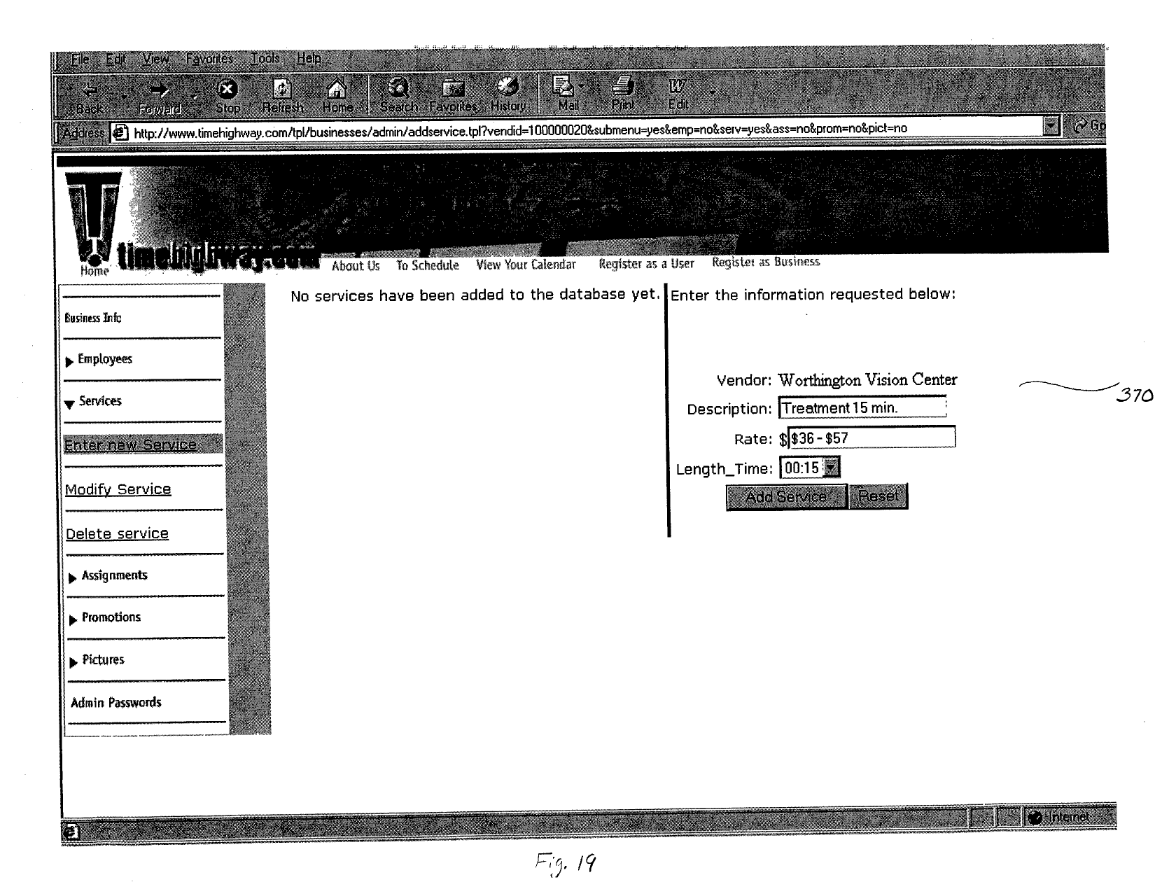

Referring to FIG. 19, an add service page in accordance with an example embodiment of the present invention is shown. The name of the vendor is displayed at the right of the page 370. A description of the service, rate for the service, and time for the service is entered 370. Primary as well as adjacent services may be defined using this page. Upon selection of the “Add Service” button, the service description is added to a database.

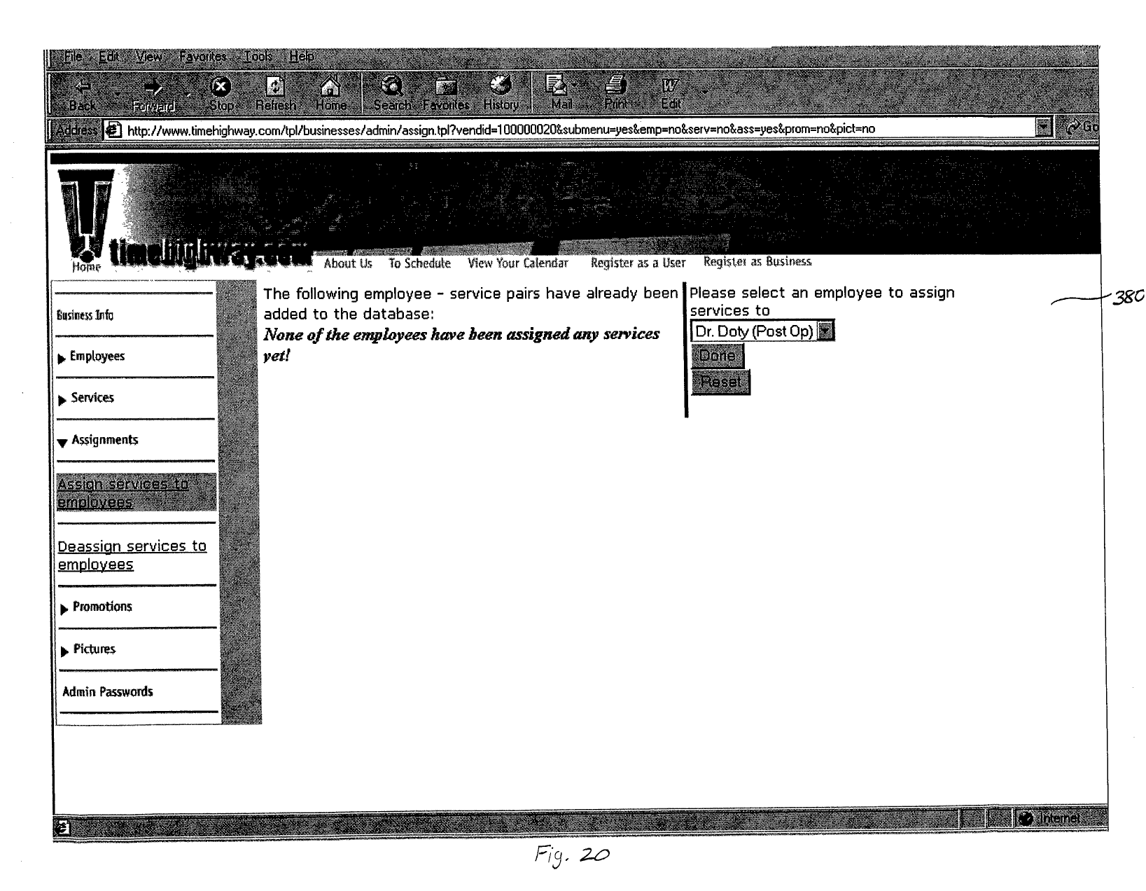

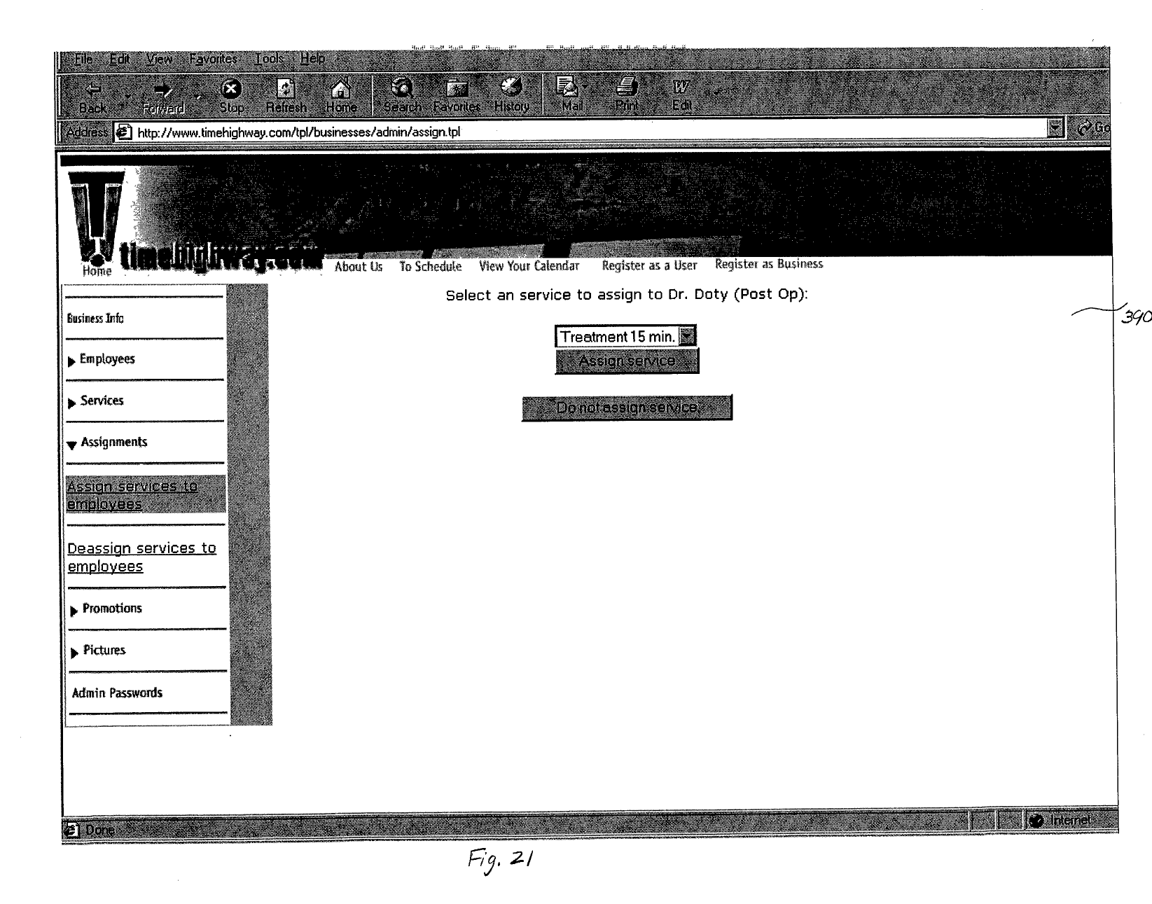

Referring to FIG. 20, an example service provider assignment page in accordance with an example embodiment of the present invention is shown. This page allows service providers or employees to be assigned to services offered by the vendor. First, a service provider is selected from a menu of service providers or employees 380. Following selection of a service provider, a service is selected from a menu of services. Referring to FIG. 21, a service assignment page in accordance with an example embodiment of the present invention is shown. Following selection of a service, the “Assign Service” button may be selected so that the selected service provider and selected service are matched. The service provider-service pair is stored in a database. This information is used when a customer wishes to have a service completed. He or she selects a service from a list of services provided by the vendor. Next, the appointment scheduling software application identifies which service providers offer that service, and at what times they are available.

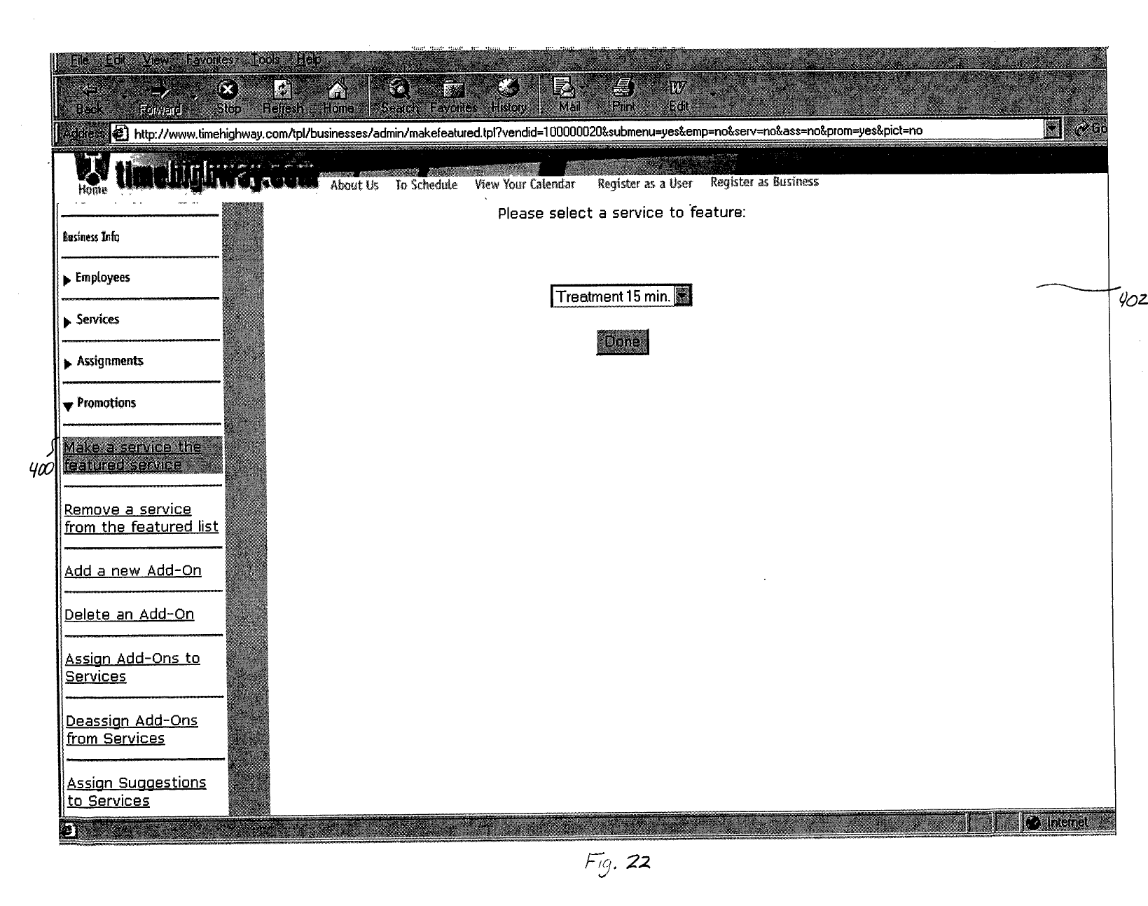

Referring to FIG. 22, a promotions page in accordance with an example embodiment of the present invention is shown. On this page, a vendor may identify featured, adjacent, and add-on services. By selecting one of the options from the menu at the right of the page, a user may define a featured, adjacent, or add-on service. The services that may be identified as featured, adjacent, or add-on may be selected from a menu of services 402. A featured service is a service that is displayed prominently on one or more pages. A customer may schedule an appointment for a featured service by simply selecting a “Schedule” button.

An adjacent service is a service identified by the vendor as an additional service that may be offered immediately before or after a primary scheduled service. For example, if a customer has scheduled a haircut, an adjacent service as defined by the vendor may be a facial. When the customer sets up the appointment for the haircut, the appointment scheduling software application checks that a timeslot following the haircut is available, and that a service provider who can provide a facial is available. If these conditions are met, the appointment scheduling software application suggests the facial service to the customer who is then given the option of adding the service.

An add-on service is a service identified by the vendor as an additional service that may be offered and added on to a scheduled service at the same time as the scheduled service. For example, an add-on may be “moustache trim.” When the customer sets up an appointment for the haircut, the appointment scheduling software application offers to the customer the add-on service of a moustache trim.

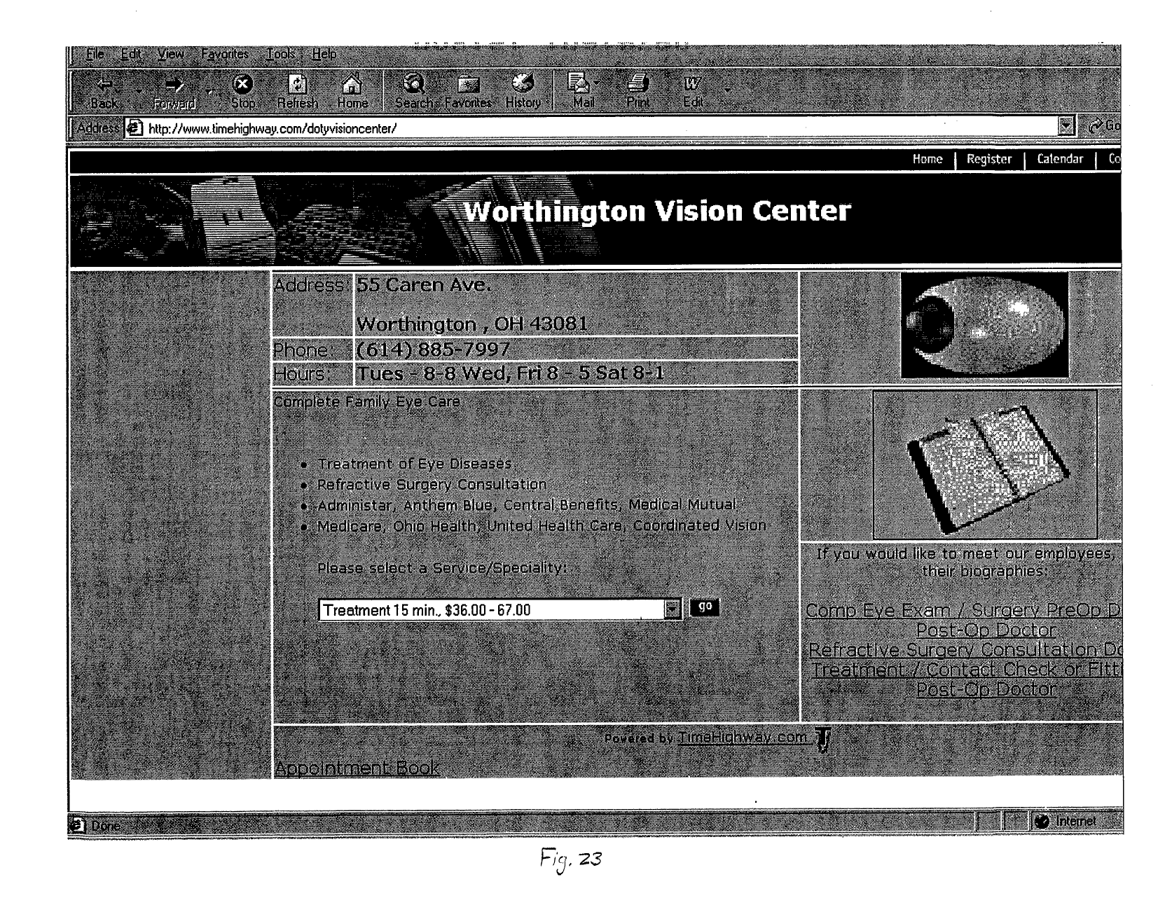

Referring to FIG. 23, a vendor home page in accordance with an example embodiment of the present invention is shown. Contact information for the vendor is displayed at the top of the page. Under the contact information, a general description of the offered services is displayed. A map and directions to the vendor may be displayed. Finally, a pulldown menu of services is displayed. Following selection of a service, a customer may begin the process of scheduling an appointment. The customer may review biographical information about the service providers by selecting one of the options from the right side of the page.

Vendors benefit from the aggregation of customer profile and appointment data stored and maintained at the central appointment repository. Vendors may generate a plurality of reports based on the data maintained at the repository to identify trends and patterns in customers and scheduling of appointments.

In accordance with the present invention, vendor, customer profile, and appointment data and other related data is stored in one or more databases. The following tables comprises the data dictionary for an example embodiment of the present invention.

Table 1 is a Cities Master file that comprises cities containing vendors who have subscribed to the appointment service of the present invention.

TABLE 1

| Column | Type | Size | Description |
|---|---|---|---|
| City_ID | Text | 4 | City Abbreviation Code |
| City_Name | Text | 35 | City Name |
| State | Text | 2 | State Name |
| Date_Added | Date | 8 | Date Added |

Table 2 is a Service Type Master file that comprises the various services offered.

TABLE 2

| Column | Type | Size | Description |
|---|---|---|---|
| Type ID | Text | 4 | Unique Code for Service Type |
| Service₁₃ | Text | 50 | Services (ex. Salon, Barber, Kennel, |
| Description | | | . . . ) |
| Date_Added | Date | 8 | Date Added to File |

Table 3 is a Vendor Master file that comprises the offerings for vendors who have subscribed to the appointment service of the present invention.

(Example: YankeeClipper Barber Shop, TeeltUp Golf Course, Fido Kennels)

TABLE 3

| Column | Type | Size | Description |
|---|---|---|---|
| Vendor_ID | Text | 4 | Unique Vendor ID code (Assigned) |
| City_ID | Text | 4 | Point to ID in City_Master |
| Type_ID | Text | 4 | Point to ServiceType_Master |
| Date_Added | Date | 8 | Date added to Master file |
| Date_Mod | Date | 8 | Date Modified |
| Vendor_Name | Text | 35 | Name of Store, Vendor or |
| Address1 | Text | 35 | Merchant |
| Address2 | Text | 35 | |
| City | Text | 35 | |
| State | Text | 2 | |
| Zip | Text | 10 | |
| Phone | Text | 15 | |
| Fax | Text | 15 | |
| E-Mail | Text | 50 | |
| HighwayURL_Name | Text | 50 | Vendor Internet ID at |
| | | | TimeHighway.com |
| WebSite_Name | Text | 50 | Vendor Web site id (if applicable) |
| Contact_Name | Text | 35 | Store Owner Name |
| Contact_Phone | Text | 15 | |
| Sun_Hours | Text | 15 | Sunday Business Hours |
| Mon_Hours | Text | 15 | For example 8:00AM - 5:00PM |
| Tues_Hours | Text | 15 | |
| Wed_Hours | Text | 15 | |
| Thur_Hours | Text | 15 | |
| Fri_Hours | Text | 15 | |
| Sat_Hours | Text | 15 | |
| Lat_Points | Num | Long | Latitude Coordinates for quick |
| | | | Map |
| Lon_Points | Num | Long | Longitude Coordinates |
| Directions_General | Text | 50 | General Directions to Vendor Site |
| Mission_Stmt | Text | 50 | Vendor Mission Statement |
| Number_Appts | Num | 4 | # Appointments allowed to |
| | | | PreSched. |
| Adv_Notice | Num | 4 | # Days Prior to Date allowed to |
| | | | Sched |
| DaysC_xI | Num | 4 | # Days Prior to Date allowed to |
| | | | CXL |
| Confirmation | Text | 150 | Confirmation Message |
| Reminder | Text | 150 | Reminder Message |
| Days_Remind | Num | 4 | # Days Prior to send Reminder |
| | | | e-mail |
| Time_Incr | Num | 8 | Time Increments for Appt. Book |
| | | | Multiples of 7 ½ Minutes. |

Table 4 is a service provider (Technician, Course name, Doctor, Subordinate to Vendor) file that comprises the service providers or employees, each of which can be selected for an appointment.

TABLE 4

| Column | Type | Size | Description |
|---|---|---|---|
| ServicePro_ID | Text | 4 | Unique Vendor ID (Assigned) |
| Vendor_ID | Text | 4 | Point to Vendor_Master |
| ServicePro_Name | Text | 35 | Vendor Name & Address |
| Address1 | Text | 35 | |
| Address2 | Text | 35 | |
| City | Text | 35 | |
| State | Text | 2 | |
| Zip | Text | 10 | |
| Phone | Text | 15 | |
| Fax | Text | 15 | |
| E-mail | Text | 50 | E-Mail address of Vendor |
| Biography | Text | 50 | Personal Biography of Vendor |
| Sun_Hours | Text | 15 | Sunday Hours for this provider |
| Mon_Hours | Text | 15 | |
| Tues_Hours | Text | 15 | |
| Wed_Hours | Text | 15 | |
| Thur_Hours | Text | 15 | |
| Fri_Hours | Text | 15 | |
| Sat_Hours | Text | 15 | |
| Heading | Text | 30 | Appointment Book Title (as it |
| | | | appears) |
| Specialty_1 | Text | 4 | Point to Specialty_Master file ID |
| Specialty_2 | Text | 4 | |
| Specialty_3 | Text | 4 | |
| Specialty_4 | Text | 4 | |
| Specialty_5 | Text | 4 | |

Table 5 is a Specialty Master file that comprises descriptions of various specialties provided by this vendor.

TABLE 5

| Column | Type | Size | Description |
|---|---|---|---|
| Specialty_ID | Text | 4 | Unique ID of various Provider Specialties |
| Description | Text | 30 | Describes the unique Specialty or Service |
| Length_Time | Text | 15 | Typical time needed for Service |
| Rate | Num | 10 | Typical Rate for this Service |

Table 6 is a Customer Master file that comprises a profile of each customer for a particular vendor. A customer may be entered multiple times. Multiple vendors may have the same customer.

TABLE 6

| Column | Type | Size | Description |
|---|---|---|---|
| Customer_ID | Text | 4 | Unique Customer ID (Assigned) |
| ServicePro_ID | Text | 4 | Points to Vendor |
| Date_Added | Date | 8 | Date Customer setup in |
| | | | TimeHighway.com |
| Date_Mod | Date | 8 | Last date Customer record modified |
| Name | Text | 35 | Customer Name |
| Address1 | Text | 35 | |
| Address2 | Text | 35 | |
| City | Text | 35 | |
| State | Text | 2 | |
| Zip | Text | 10 | |
| Phone | Text | 15 | |
| E-Mail | Text | 30 | |
| Fax | Text | 15 | |
| MobilePhone | Text | 15 | |
| Appt_Date | Date | 8 | Next Requested Appointment Date |
| Appt_Time | Num | 8 | |
| Service_Pro | Text | 4 | Code Pointing to Provider requested |
| Service_Type | Text | 4 | Code describing requested Service |
| Remarks | Text | 50 | Additional Information |
| Product1 | Text | 4 | Purchased Product (ID) |
| Product2 | Text | 4 | |
| Product3 | Text | 4 | |
| Product4 | Text | 4 | |
| Product5 | Text | 4 | |
| Prev_Appt_Dte | Date | 8 | Last Appointment |
| Prev_Appt_Time | Num | 8 | |
| Prev_ServicePro | Text | 4 | |
| Prey_ServiceType | Text | 4 | |
| Prey_Remarks | Text | 50 | |
| Prey_Product1 | Text | 4 | Previously Purchased Product (ID) |
| Prey_Product2 | Text | 4 | |
| Prey_Product3 | Text | 4 | |
| Prey_Product4 | Text | 4 | |
| Prey_Product5 | Text | 4 | |
| Total_Appts | Num | 8 | Total Number of Appointments To |
| | | | Date |
| Special_Inst | Text | 50 | Special Instructions for this Customer |

Table 7 is a Product Master file that comprises a description of the products offered by the vendor.

TABLE 7

| Column | Type | Size | Description |
|---|---|---|---|
| Product_ID | Text | 4 | Unique ID of Product |
| Product_Desc | Text | 30 | Description of Product |
| Product_Price | Num | 8 | Unit Price |
| Product_View | JPG | Blob | JPG View of product |

Table 8 is the Appointment Master file. Each Record contains one week of appointments, belonging to one vendor. Each time cell is 7½ minutes, 4 Appts./Hr. if 15 min. intervals and 8 Appts./Hr. if 7½ min intervals.

TABLE 8

| Column | Type | Size | Description |
|---|---|---|---|
| Service_Pro_ID | Text | 4 | Service Provider who owns this book |
| Sun_Date | Date | 8 | Date of First day in Week |
| Sun_Begin | Text | 4 | Beginning Time of Day Sunday (ex |
| | | | 0800) |
| Sun_Cell1 | Text | 4 | Sunday Time Cell 1. Holds |
| | | | Customer_ID. |
| Sun_Cell2 | Text | 4 | Sunday Time Cell 2 |
| Sun_Cell3 | Text | 4 | Sunday Time Cell 3 |
| Sun_Cell96 | Text | 4 | Last Time cell for Sunday, after 12 Hrs. |
| Mon_Begin | Text | 4 | Beginning Time of Day Monday |
| Mon_Cell1 | Text | 4 | Time Cell 1. Holds Customer_ID |
| Mon_Cell2 | | | |
| Mon_Cell3 | | | |
| Sat_Cell96 | Text | 4 | Last Time Cell for Saturday. End of |
| | | | Week |

The present invention allows customers of vendors to schedule appointments at any time from any location without assistance from the vendor. Vendors register with a scheduling web site and provide background and service information that may be used to create a custom web site for the vendor. In addition, appointment books are created and maintained on behalf of the vendor. Vendors as well as customers benefit from the convenient and cost-effective approach of interactive scheduling provided by the present invention. While particular embodiments of the invention have been illustrated and described, various modifications and combinations can be made without departing from the spirit and scope of the invention, and all such modifications, combinations, and equivalents are intended to be covered and claimed.

What is claimed is:

1. A system for interactive scheduling comprising:
a web server having an appointment scheduling software application for receiving a customer's vendor, service, add-on service, service provider, date, and timeslot selections; and
a central appointment repository at said web server for storing appointment data based on said customer's vendor, service, add-on service, service provider, and timeslot selections.

2. The system of claim 1 wherein said customer's vendor selection is a selection from the group consisting of personal care vendors, health care vendors, and auto care businesses.

3. The system of claim 1 further comprising a customer's adjacent service selection.

4. The system of claim 1 further comprising customer profile information for said customer.

5. The system of claim 4 wherein said appointment scheduling software application is adapted to send an email confirmation of an appointment to said customer based on said customer profile information.

6. The system of claim 1 wherein said appointment scheduling software is operational at a web site for said vendor.

7. The system of claim 1 further comprising an appointments page at said web server for said customer to review scheduled appointments with a plurality of vendors.

8. A method for scheduling an appointment comprising the steps of:
prompting a customer to select a vendor;
prompting said customer to select a service;
prompting said customer to select a service provider;
prompting said customer to select a date to receive said selected service;
prompting said customer to select a time to receive said selected service;
prompting said customer to select an add-on service based on said selected vendor, said selected service, said selected service provider, said selected date, and said selected time; and
updating a central appointment repository based on said selected vendor, said selected service, said selected service provider, said selected date to receive said selected service, said selected time to receive said selected service, and said selected add-on service.

9. The method of claim 8 wherein the step of prompting said customer to select a service comprises the step of prompting said customer to select one of a plurality of services from a menu.

10. The method of claim 9 wherein the step of prompting said customer to select an add-on service comprises the steps of:
identifying a service to be performed at the same time as the selected service;
identifying a service provider who can perform said identified service; and
presenting said identified service to said customer.

11. The method of claim 8 further comprising the step of prompting said customer to select an adjacent service.

12. The method of claim 11 wherein the step of prompting said customer to select a service comprises the steps of:
identifying a service to be performed at the same time as the selected service;
identifying a service provider who can perform said identified service; and presenting said identified service to said customer.

13. The method of claim 8 wherein the step of prompting said customer to select a time to receive said selected service comprises the step of prompting said customer to select a time at which another customer has scheduled an appointment.

14. The method of claim 8 further comprising the step of sending a email to said customer confirming said selected vendor, said selected service, said selected service provider, said selected date to receive said selected service, said selected time to receive said selected service, and said selected add-on service.

15. A method for developing an web site for interactive scheduling comprising the steps of:
prompting a user for vendor information;
prompting said user for service offering information;
prompting said user for service provider information;
prompting said user to assign at least one service provider to each service offering;
creating an appointment book for each service provider based on said service provider information;
creating a plurality of web pages based on said vendor information, service offering information, and service provider information; and
linking at least one of said web pages to an appointment scheduling software application adapted to store and maintain appointment data in said appointment book.

16. The method of claim 15 wherein the step of prompting said user for service offering information comprises the steps of:
prompting said user for a description of each service;
prompting said user for a rate for each service; and
prompting said user for a length of time for each service.

17. The method of claim 15 wherein the step of prompting said user for service provider information comprises the steps of:
prompting said user for biographical information for each service provider; and
prompting said user for hours of availability for each service provider.

18. The method of claim 15 further comprising the step of prompting said user for add-on service information.

19. The method of claim 15 further comprising the step of prompting said user for adjacent service information.

20. The method of claim 15 wherein the step of creating a plurality of web pages comprises the steps of:
creating a home page based on said vendor information; and
creating a promotions page based on said service offering information.
